(19) United States
(12) Patent Application Publication
(10) Pub. No.: US 2026/0103204 A1
(43) Pub. Date: Apr. 16, 2026

(54) RECREATIONAL ACTIVITY SYSTEMS AND METHODS

(71) Applicant: Dryft Board LLC, Los Angeles, CA (US)

(72) Inventor: Ralph ZIPPER, Melbourne, FL (US)

(21) Appl. No.: 19/056,201

(22) Filed: Feb. 18, 2025

Related U.S. Application Data
(63) Continuation-in-part of application No. 18/913,716, filed on Oct. 11, 2024, now Pat. No. 12,296,916.
(63) Continuation-in-part of application No. 18/913,750, filed on Oct. 11, 2024, now Pat. No. 12,428,093.
(63) Continuation-in-part of application No. 18/913,780, filed on Oct. 11, 2024, now Pat. No. 12,286,191.
(63) Continuation-in-part of application No. 18/913,829, filed on Oct. 11, 2024, now Pat. No. 12,291,295.
(63) Continuation-in-part of application No. 18/991,019, filed on Dec. 20, 2024, now abandoned.
(60) Provisional application No. 63/741,241, filed on Jan. 2, 2025.

(51) Int. Cl. B60W 40/09; B60W 40/08; B60W 50/08

(52) U.S. Cl. CPC B60W 40/09; B60W 50/085; B60W 2040/0809

(57) ABSTRACT

Recreational activity systems (350) comprise a plurality of recreational apparatuses (352), a plurality of users (354), a plurality of mobile devices (356), and one or more servers (360). Recreational apparatuses (352) comprise a controller (362) that is configured to control aspects of the recreational apparatus (352) based at least in part on an identification (364) of a particular user (354) of the recreational apparatus (352). The controller (362) is configured to limit one or more performance aspects (366) of the recreational apparatus (352) based at least in part on the identification (364) of the particular user (354), and/or control activation of one or more features (378) of the recreational apparatus (352) based at least in part on the identification (364) of the particular user (354).

### RELATED APPLICATIONS

This application is a continuation-in-part of and claims priority to U.S. patent application Ser. Nos. 18/913,716, 18/913,750, 18/913,780, 18/913,829, and 18/991,019, the disclosures of which are incorporated herein by reference. This application also claims priority to U.S. Provisional Ser. No. 63/741,241 , the disclosure of which is incorporated herein by reference. Also incorporated herein by reference are U.S. Pat. No. 11,305,830 and U.S. patent application Ser. No. 18/352,993.

### FIELD The present disclosure relates to recreational activity systems and methods.

### BACKGROUND

Recreational activities, such as board sports (e.g., skateboarding, snowboarding, wakeboarding, skiing, etc.), vehicular activities (e.g., scootering, e-scootering, ATVing, etc.), and the like, are inherently social activities where participants share their experiences with others, both in real-time (e.g., casually or in-competition) and also after-the-fact (e.g., telling stories, watching videos, reading content, interacting with media, posting on social media, etc.).

### SUMMARY

Recreational activity systems may comprise and/or interact with one or more of a plurality of recreational apparatuses (e.g., vehicles), a plurality of users, a plurality of mobile devices (e.g., smart phones) running mobile applications associated with the plurality of users, and one or more servers.

Recreational apparatuses comprise a controller that is configured to control aspects of the recreational apparatus based at least in part on an identification of a particular user of the recreational apparatus. For example, in some examples, the controller is configured to limit one or more performance aspects of the recreational apparatus based at least in part on the identification of the particular user, and/or control activation of one or more features of the recreational apparatus based at least in part on the identification of the particular user.

Some methods comprise controlling aspects of a recreational apparatus based at least in part on an identification of a particular user of the recreational apparatus. For example, in some methods, the controlling comprises limiting one or more performance aspects of the recreational apparatus, and/or activating one or more features of the recreational apparatus.

Some methods (e.g., performed by or on a mobile device) comprise receiving from a recreational apparatus data associated with one or more conditions sensed by the recreational apparatus, sending to the recreational apparatus data associated with historical data of a particular user of the recreational apparatus or of a plurality of recreational apparatuses, and/or receiving from a server the data associated with the historical data.

Some methods (e.g., performed by or on a server) comprise sending to a mobile device data associated with historical data of a particular user of a recreational apparatus or of any one of a plurality of recreational apparatuses.

Some methods (e.g., performed by or on a recreational apparatus, a mobile device, and/or a server) comprise collecting geographic data associated with an instance of use of a recreational apparatus of a plurality of recreational apparatuses, and receiving user input associated with the instance of use of the recreational apparatus.

### BRIEF DESCRIPTION OF THE DRAWINGS

FIG. 1 is a schematic side view representing vehicles according to the present disclosure.

FIG. 2 a schematic rear view representing vehicles according to the present disclosure.

FIG. 3 is a schematic cross-sectional view representing truck wheels according to the present disclosure.

FIG. 4 is a side view of an example vehicle according to the present disclosure.

FIG. 5 is a front angled view of the vehicle of FIG. 4.

FIG. 6 is rear angled view of the vehicle of FIG. 4.

FIG. 7 is a detailed partially exploded view of the vehicle of FIG. 4, showing operative attachment of the rearward assembly to the forward assembly of the vehicle.

FIG. 8 is another detailed view of the vehicle of FIG. 4, showing operative attachment of the rearward assembly to the forward assembly of the vehicle in sequence with FIG. 7.

FIG. 9 is another detailed view of the vehicle of FIG. 4, showing operative attachment of the rearward assembly to the forward assembly of the vehicle in sequence with FIGS. 7 and 8.

FIG. 10 is another detailed view of the vehicle of FIG. 4, showing the lever of the quick-disconnect assembly in an open position.

FIG. 11 is a detailed bottom view of the vehicle of FIG. 4, showing attachment of the rearward assembly to the forward assembly of the vehicle.

FIG. 12 is a detailed view of the vehicle of FIG. 4, showing the limiter in the first configuration.

FIG. 13 is another detailed view of the vehicle of FIG. 4, showing the limiter with the limiter pin in the unlocked position.

FIG. 14 is another detailed view of the vehicle of FIG. 4, showing the limiter in the second configuration.

FIG. 15 is another detailed view of the vehicle of FIG. 4, showing the limiter with the limiter pin in the unlocked position.

FIG. 16 is an angled view of the vehicle of FIG. 4, shown in an inverted, self-standing position.

FIG. 17 is a detailed rear view of the vehicle of FIG. 4.

FIG. 18 is an angled lateral view of a truck wheel according to the present disclosure.

FIG. 19 is an angled lateral view of the core of the truck wheel of FIG. 18.

FIG. 20 is an angled lateral cross-sectional view of the core of the truck wheel of FIG. 18.

FIG. 21 is a flowchart schematically representing methods of riding vehicles according to the present disclosure.

FIG. 22 is another flowchart schematically representing methods of riding vehicles according to the present disclosure.

FIG. 23 is a schematic diagram representing recreational activity systems according to the present disclosure.

FIG. 24 is a flowchart schematically representing methods according to the present disclosure.

FIG. 25 is a flowchart schematically representing methods according to the present disclosure.

FIG. 26 is a table of example speed-values used by example recreational activity systems and methods according to the present disclosure.

FIG. 27 is a table of example time-values used by example recreational activity systems and methods according to the present disclosure.

FIG. 28 illustrates an example display associated with an example vehicle of a recreational activity system according to the present disclosure, prior to initiation of a ride.

FIG. 29 illustrates the example display of FIG. 28, at a first instance of a ride of the vehicle.

FIG. 30 illustrates the example display of FIG. 28, at a second instance of the ride of the vehicle.

FIG. 31 illustrates the example display of FIG. 28, at a third instance of the ride of the vehicle.

FIG. 32 is a flowchart schematically representing methods according to the present disclosure.

### DESCRIPTION

Recreational apparatuses, including vehicles and various components parts thereof, as well as recreational activity systems that comprise a plurality of recreational apparatuses are disclosed herein and associated methods are disclosed herein. The various component parts, such as wheels and wheel assemblies, are not required to be used with vehicles according to the present disclosure and may be used with, or may be components of, other vehicles and/or may be used in other applications.

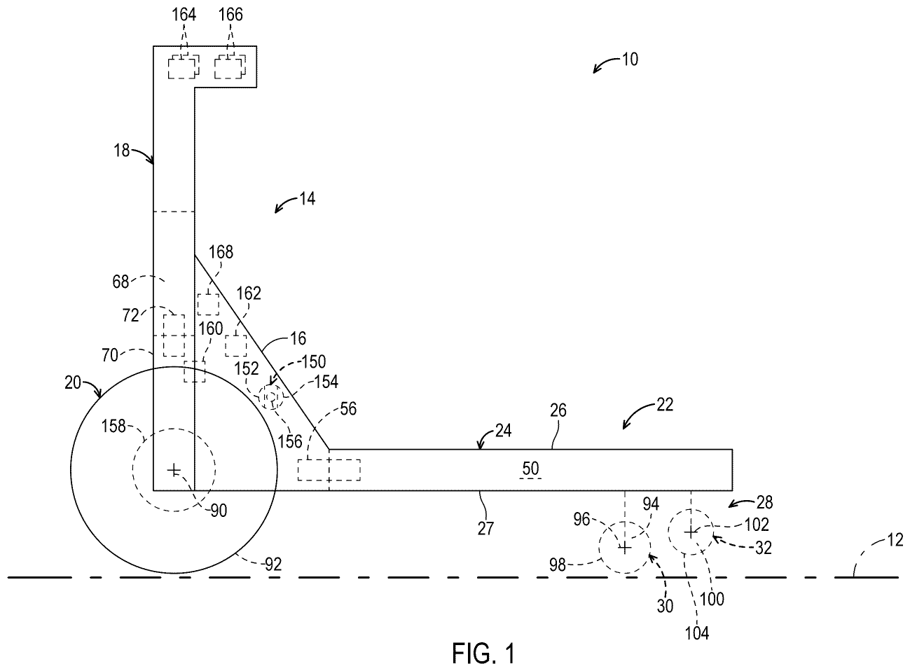

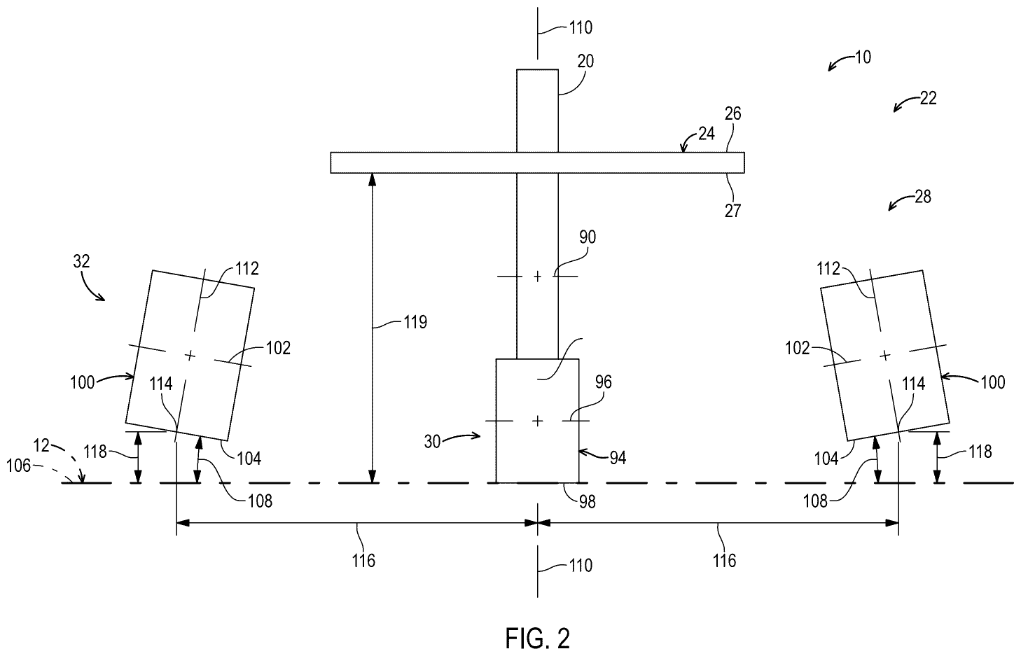

FIGS. 1-3 schematically represent vehicles and wheels. Generally in FIGS. 1-3, elements that are likely to be included in a given example are illustrated in solid lines, while elements that are optional to a given example or that correspond to a specific example are illustrated in dashed lines. However, elements that are illustrated in solid lines are not essential to all examples of the present disclosure, and an element shown in solid lines may be omitted from a particular example without departing from the scope of the present disclosure. Dash-dot lines in FIGS. 1 and 2 represent environment.

Herein, the terms “forward,” “rearward,” “front,” “rear,” “left,” “right,” “upper”, “lower” and the like are relative terms used to describe position, location, and/or direction of vehicles and components thereof, and should be interpreted with the vehicle in an upright position on a flat ground surface and having a primary direction of “forward” travel. The term “lateral” means away from a centerline or center plane of a referenced structure, and the term “medial” means toward a centerline or center plane of a referenced structure.

With reference to FIG. 1, vehicles 10 according to the present disclosure are for riding along a ground surface 12 and generally comprise at least a forward assembly 14 and a rearward assembly 22. The forward assembly 14 comprises a front frame assembly 16, a steering assembly 18 that is rotationally, or pivotally, supported by the front frame assembly 16, and a front wheel 20 that is operably coupled to the steering assembly 18 and that is positioned to engage the ground surface 12. The rearward assembly 22 is coupled to and extends rearward from the forward assembly 14. The rearward assembly 22 comprises a deck 24 and a rear wheel assembly 28 that is operably coupled to the deck 24 and that is positioned to engage the ground surface 12 when the front wheel 20 engages the ground surface 12. The deck 24 has an upper side 26 for supporting a rider in a standing position, and a lower side 27 that is opposite the upper side 26.

The deck 24 additionally or alternatively may be described as or referred to as a board and may take a variety of configurations. For example, the deck 24 may comprise at least a main body 50 that is configured similar to or that has characteristics of other board sport boards, like scooters, skateboards, wakeboards, and snowboards. In particular, the main body 50 of the deck 24 may be generally planar and/or may be contoured like modern day skateboard decks to facilitate a secure footing on the upper side 26 of the deck 24. The main body 50 may be constructed of any suitable material, including one or more of wood, wood laminate, plastic, fiber glass, fiber reinforced plastic, composite, etc., and may include features such as one or more grip surfaces and/or textures on the upper side 26 thereof. The deck 24 may be appropriately sized to receive one or two or more riders in a standing position at a given time. As illustrative examples only, the deck 24 may have a length in the range of 400-1000 millimeters (mm) and a width in the range of 100-400 mm.

In some examples of vehicles 10, the rearward assembly 22, including the deck 24, is configured to be selectively detached from and reattached to the forward assembly 14. In such examples, a user may remove the rearward assembly 22 to perform maintenance on the rearward assembly 22, such as on the rear wheel assembly 28, and/or to install a different (e.g., new or differently configured) rearward assembly 22. For example, multiple configurations of rearward assemblies 22, including decks 24 and rear wheel assemblies 28, may be provided to enable a user to select a specific rearward assembly 22 for a particular application or riding characteristic. For example, some rearward assemblies 22 may be configured for on-road use while others may be configured for off-road use. Some rearward assemblies 22 may be configured for racing while others may be configured for recreational activities. Some rearward assemblies 22 may be configured for beginner riders, while others may be configured for more expert riders. Some rearward assemblies 22 may be configured for more aggressive drifting or powersliding, while others may be configured for more conservative drifting or powersliding. Some rearward assemblies 22 may be configured for only a single rider while others may be configured for more than one rider. Other variations and applications for rearward assemblies 22, including decks 24 and rear wheel assemblies 28 are within the scope of the present disclosure. Additionally, the rearward assembly 22 may be selectively removed from the forward assembly 14 to facilitate travel, shipping, and/or storage of the vehicle 10.

As schematically represented in FIG. 1, in some examples, the forward assembly 14 and the rearward assembly 22 collectively define a quick-disconnect assembly 56 that is configured to selectively release and secure the rearward assembly 22 from and to the forward assembly 14. The quick-disconnect assembly 56, when present, permits the removal of the rearward assembly 22 from the forward assembly 14 without the use of hand tools (e.g., screw drivers or wrenches), yet still provides a secure, fixed attachment between the forward assembly 14 and the rearward assembly 22 during operative use of the vehicle 10. In some examples, the quick-disconnect assembly 56 is operable solely by engagement with a user's hand or hands.

As also schematically represented in FIG. 1, in some examples of vehicles 10, the front frame assembly 16 comprises a head tube 68, and the steering assembly 18 comprises a steering tube 70 that rotatably extends through the head tube 68 and that operably is coupled to the front wheel 20. Accordingly, selective rotation of the steering tube 70 by a rider will cause the front wheel 20 to rotate relative to the head tube 68 for operative steering of the vehicle 10. In some examples of vehicles 10, the forward assembly 14 further comprises a limiter 72 that is configured to selectively limit rotation of the steering tube 70 relative to the head tube 68. For example, in some examples, the limiter 72 limits rotation, or pivoting, of the steering tube 70 to a defined angular span, such as to prevent a rider from rotating the front wheel 20 beyond a threshold angle relative to the head tube 68. For example, the angular span may be less than 180 degrees (°) or less. In some examples, the limiter 72 may be configured between a limiting configuration, in which rotation of the steering tube 70 is limited, and a non-limiting configuration, in which rotation of the steering tube 70 is not limited. Additionally or alternatively, some limiters 72 may be configured to be selectively configured between a first configuration, in which the steering tube 70 is limited to an angular range of rotation relative to the head tube 68, and a second configuration, in which the steering tube 70 is limited to no rotation relative to the head tube 68. This second configuration may be useful, for example, while a user performs maintenance on the vehicle 10. Additionally, in some examples, by limiting the steering tube 70 to no rotation relative to the head tube 68, the vehicle 10 may be inverted and placed on a ground surface, with the steering assembly 18 and the rearward assembly 22 serving as a tripod configuration, without worry of the steering assembly 18 rotating and causing instability of the inverted vehicle 10. When so positioned, a user may perform maintenance on the vehicle and/or may remove and/or replace the rearward assembly 22.

With continued reference to FIG. 1, in some examples of vehicles 10, the rear wheel assembly 28 comprises one or more caster assemblies 30 that are operably coupled to the deck 24 opposite the upper side 26, and a truck assembly 32 that is operably coupled to the deck 24 opposite the upper side 26 and rearward of the one or more caster assemblies 30. In some examples, a single caster assembly 30 is present and is centered along the deck 24. In some examples, two caster assemblies 30 are present and equally spaced from a center line of the deck 24.

Such vehicles 10 may be described as drift vehicles and/or as being configured to facilitate drifting and/or powersliding maneuvers by riders. In other words, the rearward assembly 22 of the vehicle may be configured to be rotatable to a range of angles relative to the direction of motion during controlled operation of the vehicle 10, and/or to “drift” or “powerslide” relative to the direction of vehicle motion. Examples of similar drifting vehicles are disclosed in U.S. Pat. No. 11,305,830, the disclosure of which is incorporated herein by reference.

FIG. 2 schematically illustrates such a rear wheel assembly 28 comprising a single caster assembly 30 and a truck assembly 32. Caster assemblies 30 generally comprise a caster wheel 94 that is configured to pivot about an axis that is perpendicular or transverse to the caster wheel's rotational axis, and in particular that is transverse to the deck 24. Examples of caster assemblies 30 that may be incorporated into a rear wheel assembly 28 of a vehicle 10 are disclosed in U.S. patent application Ser. No. 18/352,993, the disclosure of which is incorporated herein by reference. For example, in some examples, the caster assembly 30 may be configured to be selectively locked to restrict the caster wheel 94 from pivoting about the caster assemblies pivot axis, such as with the caster wheel 94 being aligned with the deck 24. When such a caster assembly 30 is locked, the vehicle 10 may be described as being configured for carving rather than drifting, and when the caster assembly 30 is unlocked and permitted to pivot, the vehicle 10 may be described as being configured for drifting and not carving.

Truck assemblies 32 may take a variety of configurations, but generally include a pair of truck wheels 100 that are configured to move vertically or pivot relative to the deck 24 and that have a neutral configuration, to which the truck assembly 32 is spring-biased and in which both truck wheels 100 are equidistant from the deck 24. Some truck assemblies 32 may be configured similar to skateboard truck assemblies, with a single axle, to which both truck wheels 100 are operably mounted, and that is configured to pivot relative to the deck 24. Other truck assemblies 32 may comprise a separate axle associated with each truck wheel 100 that individually is configured to pivot relative to the deck 24, with such truck assemblies 32 optionally being described as defining an independent suspension configuration.

As schematically represented in FIG. 2, the caster assembly 30 comprises a caster wheel 94 having a caster-wheel axis 96 and a caster-wheel ground-contacting surface 98, and the truck assembly 32 comprises a pair of truck wheels 100. Each truck wheel 100 has a truck-wheel axis 102 and a truck-wheel ground-contacting surface 104. In some examples, the truck-wheel ground-contacting surface 104 is cylindrical or generally cylindrical; however, the truck-wheel ground-contacting surface 104 also may be frustoconical and or become frustoconical over time as the truck-wheel ground-contacting surface 104 is worn down through use. Additionally, the truck-wheel ground-contacting surface 104 may have texture or a tread pattern and is not required to be smooth.

The front wheel 20 has a front-wheel axis 90 and a front-wheel ground-contacting surface 92 (FIG. 1), and with reference to FIG. 2, the geometry of the vehicle 10, including the rearward assembly 22 and the rear wheel assembly 28, may be referenced, and is described herein, when (i) the front-wheel axis 90 and the caster-wheel axis 96 are parallel to a planar ground surface 106, (ii) the front-wheel ground-contacting surface 92 and the caster-wheel ground-contacting surface 98 are engaged with the planar ground surface 106, (iii) and the truck assembly 32 is in a neutral configuration.

In particular, when the vehicle 10 is in such a reference configuration, (i) the truck-wheel ground-contacting surface 104 and/or the truck-wheel axis 102 of each truck wheel 100 may be described as being at a truck-wheel angle 108 relative to the planar ground surface 106, (ii) the vehicle 10 may be described as having a vehicle center plane 110 that bisects the vehicle 10 and that is perpendicular to the planar ground surface 106, (iii) the closest distance from an intersection 114 of the truck-wheel center plane 112 and the truck-wheel ground-contacting surface 104 closest to the planar ground surface 106 to the vehicle center plane 110 may be described as a truck-wheel track 116, (iv) a closest distance from the intersection 114 to the planar ground surface 106 may be described as a truck-wheel height 118, and (v) a closest distance from the lower side 27 of the deck 24 to the planar ground surface 106 may be described as a deck height 119.

In some examples, the truck-wheel angle 108 is non-zero. In some such examples, the truck-wheel angle 108 is 1-5°, 1-3°, or 1-2°. In some examples, the truck-wheel track 116 is 150-500 millimeters (mm), 150-400 mm, 150-300 mm, 150-250 mm, 200-500 mm, 200-400 mm, 200-300 mm, or 200-250 mm. In some examples, the truck-wheel height 118 is 5-80 mm, 5-60 mm, 5-40 mm, 5-30 mm, 5-20 mm, 5-10 mm, 10-50 mm, 10-40 mm, 10-30 mm, 10-20 mm, 10-15 mm, or about 22 mm. In some examples, the deck height 119 is 70-200 mm, 70-150 mm, 70-120 mm, 90-200 mm, 90-150 mm, 90-120 mm, or about 111 mm. In some examples, a ratio of the truck-wheel track 116 to the truck-wheel height 118 is 15-30, 15-25, 15-20, 20-30, 20-25, or about 22. In some examples, a ratio of the truck-wheel track 116 to the deck height 119 is 0.5-5, 0.5-4, 0.5-3, 1-5, 1-4, 1-3, 2-5, 2-4, 2-3, or about 2.1. In some examples, a ratio of the deck height 119 to the truck-wheel height 118 is 5-20, 5-15, 5-12, 10-20, 10-15, 10-12, or about 10.4. Herein, the term “about” when used in reference to a value means within 5% of the value, inclusive of the value itself.

Selections of values and ratios thereof within these various ranges are not arbitrary and may be selected such as based on the overall dimensions of the vehicle 10, including the rearward assembly 22 and the rear wheel assembly 28, and/or on the desired applications and drifting and/or powersliding characteristics of the vehicle 10. For example, values of the truck-wheel angle 108 and/or the truck-wheel track 116 may be selected to achieve a particular amount or quality of contact between the truck-wheel ground-contacting surface(s) 104 and the ground surface 12 during a drifting maneuver. In some examples, values of the truck-wheel angle 108 and/or the truck-wheel track 116 may be selected to maximize contact between each respective ground-contacting surface 104 and the ground surface 12 during a drifting maneuver, for instance values resulting in parallel or flush contact between truck-wheel ground-contacting surface 104 and the ground surface 12. In other words, the geometry of the rear wheel assembly 28 may be chosen so that the truck-wheel angle 108 reaches zero (or any other desired angle) on a side of the vehicle 10 where the truck wheel 100 contacts the ground surface 12 during a drifting maneuver. Values and ratios outside of the ranges and ratios expressly enumerated herein also are within the scope of the present disclosure.

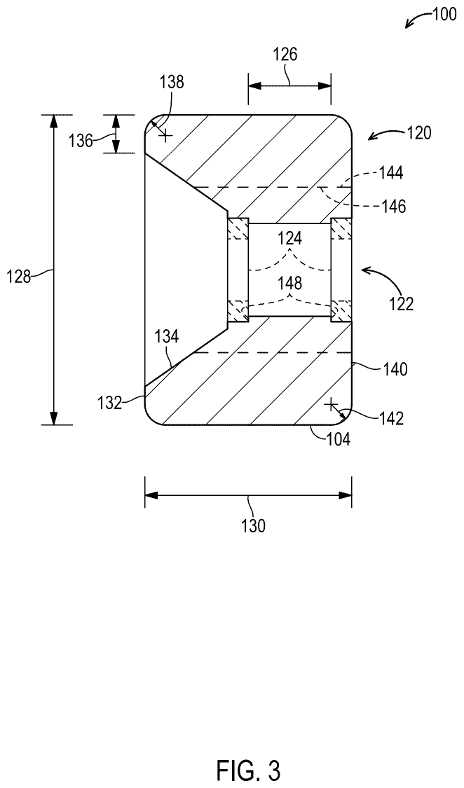

Turning now to FIG. 3, examples of truck wheels 100 are schematically presented. As schematically illustrated, generally, each truck wheel 100 comprises at least a body 120 that defines an axle bore 122, and a pair of roller bearings 124 that are operatively received within the axle bore 122. As schematically represented in FIG. 3, the pair of roller bearings 124 may be described as being spaced apart by a bearing spacing 126, and each truck wheel 100 may be described as having a truck-wheel diameter 128 and a truck-wheel width 130.

In some examples of truck wheels 100, the bearing spacing 126 is at least 12 mm, 11-25 mm, 12-25 mm, 13-25 mm, 14-25 mm, 11-20 mm, 12-20 mm, 13-20 mm, 14-20 mm, about 14 mm, about 15 mm, or about 16 mm. This is in contrast to standard skateboard truck wheels, which generally have a bearing spacing in the range of 8 to 10 mm, which spacing may be unsuitable for vehicles 10 according to the present disclosure that specifically are configured for drifting and powersliding maneuvers.

In some examples, a ratio of the truck-wheel diameter 128 to the bearing spacing 126 is 4-10, 5-10, 6-10, 4-9, 4-8, 4-7, 5-7, or about 6. In some examples, a ratio of the truck-wheel width 130 to the bearing spacing 126 is 1-5, 2-5, 3-5, 3-4, or about 3⅓. In some examples, a ratio of the truck-wheel diameter 128 to the truck-wheel width 130 is 1-2.5, 1.2-2.5, 1.4-2.5, 1-2, 1.2-2, 1.4-2, 1.6-2, or about 1.8.

Selections of values within these various ranges are not arbitrary and may be selected such as based on the overall dimensions of the vehicle 10, including the rearward assembly 22 and the rear wheel assembly 28, and/or on the desired applications and drifting and/or powersliding characteristics of the vehicle 10. Values and ratios outside of the ranges and ratios expressly enumerated herein also are within the scope of the present disclosure. In particular, the bearing spacing 126 may be critical to maintain stability of a vehicle 10 during a drifting or powersliding maneuver (i.e., to avoid vibrations induced in the truck wheels 100 induced by the friction with the ground surface 12).

With continued reference to FIG. 3, in some examples of truck wheels 100, the body 120 has a lateral sidewall 132 and a recess 134 that extends from the lateral sidewall 132 toward the axle bore 122. The lateral sidewall 132 may be described as having a sidewall depth 136 from the truck-wheel ground-contacting surface 104 to the recess 134. In some examples of truck wheels 100, such as schematically represented in FIG. 3, the recess 134 is frustoconical or approximately frustoconical, such as with a slight concave or bowl shape.

In some examples, the sidewall depth 136 is 5 -15 mm, 7-15 mm, 5-12 mm, 7-12 mm, 7-10 mm, about 10 mm, or about 9 mm. In some examples, a ratio of the truck-wheel diameter 128 to the sidewall depth 136 is 5-15, 7-15, 9-15, 5-12, 7-12, 9-12, or about 10. In some examples, a ratio of the truck-wheel width 130 to the sidewall depth 136 is 3-9, 3-7, 5-7, 5-6, or about 5.5. In some examples, a transition between the truck-wheel ground-contacting surface 104 to the lateral sidewall 132 has a radius of curvature 138 of 2-10 mm, 2-8 mm, 2-6 mm, 4-10 mm, 4-8 mm, 4-6 mm, or about 5 mm. In some examples, the body 120 has a medial sidewall 140 opposite the lateral sidewall 132, and a transition between the truck-wheel ground-contacting surface 104 to the medial sidewall 140 has a radius of curvature 142 of 2-10 mm, 2-8 mm, 2-6 mm, 4-10 mm, 4-8 mm, 4-6 mm, or about 5 mm.

Selections of values within these various ranges are not arbitrary and may be selected such as based on the overall dimensions of the vehicle 10, including the rearward assembly 22 and the rear wheel assembly 28, and/or on the desired applications and drifting and/or powersliding characteristics of the vehicle 10. Values and ratios outside of the ranges and ratios expressly enumerated herein also are within the scope of the present disclosure. In particular, the various dimensions and ratios thereof of truck wheels 100 may be critical to maintain stability of a vehicle 10 during a drifting or powersliding maneuver (i.e., to avoid vibrations induced in the truck wheels 100 induced by the friction with the ground surface 12, to avoid excessive chirping, and to avoid so-called high-siding when the friction between a forward edge of a truck wheel 100 and the ground surface 12 surpasses a threshold and causes the entire vehicle 10, and rider thereof, to uncontrollably pivot forward and potentially crash).

With continued reference to FIG. 3, in some examples of truck wheels 100, the body 120 comprises a core 144 that defines the axle bore 122, and a tire 146 that is operatively coupled to the core 144 and that defines the truck-wheel ground-contacting surface 104. In some such examples, the core 144 and the tire 146 are constructed of different materials. For example, the core 144 may be constructed of a hard plastic, and the tire 146 may be constructed of polyurethane.

Turning back to FIG. 1, in some examples of vehicles 10, the forward assembly 14 further comprises a pair of opposing frame sliders 150 that are operably supported by and that extend laterally from the front frame assembly 16. A frame slider is a structure, such as often used on motorcycles, to protect components of the motorcycle should the motorcycle inadvertently be laid-over, whether knocked-over or during a crash. Frame sliders 150 additionally or alternatively may be described as or referred to as slider pegs, frame pegs, or skid pegs.

In some examples of vehicles 10, each frame slider 150 is generally cylindrical, although other shapes also may be utilized. In some examples, each frame slider 150 is 30-100 mm long. In some examples, each frame slider 150 is positioned within 100 mm, 200 mm, or 300 mm of the deck 24 and/or within 100 mm, 200 mm, 300 mm, or 400 mm of the ground surface 12.

As schematically represented in FIG. 1, in some examples of vehicles 10, each frame slider 150 comprises one or more of a forward-facing light(s) 152, a rearward-facing light(s) 154, and/or a lateral-facing light(s) 156. Stated differently, in some examples of vehicles 10, one or more a forward-facing light 152, a rearward-facing light 154, and/or a lateral-facing light 156 are integrated into the frame sliders 150. In some examples, the integral lights are configured to illuminate portions of an underlying riding surface to the lateral sides of the vehicle 10 and/or are positioned so that typical lines of sight of observers are not blocked by the rider of the vehicle 10. Typical electric scooters and motorcycles, for example, have lights integrated at the very rear of the vehicle. However, when vehicles 10 according to the present disclosure are configured with a removable rearward assembly 22, such as described herein, having lights integrated into the rearward assembly 22 would require a complex electrical connection between the forward assembly 14 and the rearward assembly 22, for example if an associated battery were supported by the front frame assembly 16, or would require a battery supported by the rearward assembly 22. In examples of vehicle 10 with a powered front wheel 20, inclusion of a separate battery associated with rear lights would result in added weight and expense. Accordingly, integrating lights with the frame sliders 150 supported by the front frame assembly 16 is advantageous and takes advantage of a power source already present as part of the forward assembly 14. Moreover, integrating lights into frame sliders adds additional functionality to vehicles 10 not present in standard electric push scooters, for example.

Moreover, by being positioned on the frame sliders 150 that extend laterally away from the front frame assembly 16, the lights will be readily visible to the front and rear of the vehicle, without a rider blocking the lights from the rear. In addition, by having the frame sliders 150, and thus the integral lights, within a certain distance of the ground surface 12, enhanced visibility may be achieved without creating a blinding beam angle such as those created by lighting placed higher on the vehicle. Another advantage of integrating lights with the frame sliders 150 as part of the forward assembly 14 is that during a drift or powerslide maneuver of the vehicle 10, in which the rearward face of the vehicle is skewed possibly up to almost 90°relative to the direction of travel, at least one of the frame sliders 150 will be visible from behind the vehicle 10. Similarly, during a drifting maneuver, the illumination provided by frame sliders 150 may extend to some extent in lateral directions relative to the overall direction of vehicle motion, providing the rider with enhanced visibility of the underlying riding surface that drifting portions of the vehicle (i.e., the angled board) is approaching.

The forward-facing light(s) 152 may serve as headlights, such as during operation of the vehicle in reduced light settings. The rearward-facing light(s) 154 may serve as brake lights, and one or more of the forward-facing light(s) 152, the rearward-facing light(s) 154, and/or the lateral-facing light(s) 156 may serve as signal indicators (i.e., blinkers) and/or as running lights that serve to increase the visibility of the vehicle 10. In addition, the forward-facing lights and the lateral-facing lights may serve to provide illumination of the riding surface. In particular, as described previously, the lateral-facing lights 154 may provide enhanced illumination of portions of the underlying riding surface as they are approached by the board during a drifting maneuver.

With continued reference to FIG. 1, the forward assembly 14 of some vehicles 10 may comprise one or more of a battery 162, one or more user controls 164, one or more user displays 166, one or more sensors 160, and one or more controllers 168 that are configured to control various aspects of vehicle 10, including the battery 162, the user controls 164, the user displays 166, the sensors 160. Additionally, a controller 168 may be configured to communicate with a separate computing device, such as a smart phone via wireless signals. Examples of user controls 164 include throttles, brake levers, on/off switches, etc. Examples of user displays 166 include display screens, light emitting diodes (LEDs), dials, etc. for communicating such information as speed, battery life, mode, etc. Examples of sensors 160 include speedometers and drift sensors. A drift sensor is a sensor that is configured to measure a drift position of the vehicle 10, which may be defined as an angle of the rearward assembly 22 relative to the direction of travel, an angle between the front wheel 20 and the rearward assembly 22, an angle between the steering tube 70 and the head tube 68, and the like. Additional sensors may measure the pitch, roll, and/or yaw of one or more structures of the vehicle 10, such as relative to the ground surface 12.

In some examples of vehicles 10, a throttle is configured to send signals to the controller 168, which in turn sends a power signal to a motor for operation of the vehicle 10. In typical recreational wheeled vehicles, such as electric push scooters, the motor controller is configured to prevent roll-back (i.e., backward rotation of the drive wheel) and/or to turn-off or disengage the motor when roll-back is sensed. A controller 168 of a vehicle 10, on the other hand, may be configured to permit motor roll-back (i.e., to allow backward rotation of the front wheel 20 and to not turn-off or disengage the motor during roll-back). Such a configuration may facilitate certain drifting and/or powersliding maneuvers by a vehicle 10. For example, backward rotation of the front wheel 20 can occur when a drifting maneuver includes significant pivoting of the rearward assembly 22 relative to the direction of travel of the vehicle 10. To control the drift or powerslide, the rider must be able to overcome the backward rotation of the front wheel 20 and power out of the drift/slide with forward rotation of the wheel. If the front wheel 20 is not permitted to spin backward or if the controller 168 were to cause the motor to disengage or turn-off during backward rotation of the front wheel 20, powering out of the drift/slide may be difficult or even impossible.

Controllers according to the present disclosure, including the controller 168, may be any suitable device or devices that are configured to perform the functions of the controller discussed herein. For example, the controller may include one or more of an electronic controller, a dedicated controller, a special-purpose controller, a special-purpose computer, a display device, a logic device, a memory device, and/or a memory device having non-transitory computer-readable media suitable for storing computer-executable instructions for implementing aspects of vehicles 10 according to the present disclosure. Controllers or electronic controllers may include processing logic programmed with instructions to carry out a controlling function with respect to a control element. For example, an electronic controller may be configured to receive an input signal, compare the input signal to a selected control value or setpoint value, and determine an output signal to a control element (e.g., a motor or actuator) to provide corrective action based on the comparison. In another example, an electronic controller may be configured to interface between a host device (e.g., a mobile device, a desktop computer, a server, a mainframe, etc.) and a peripheral device (e.g., a memory device, an input/output device, etc.) to control and/or monitor input and output signals to and from the peripheral device. Processing logic describes any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (AI) accelerators, digital signal processors (DSPs), and/or any other suitable combination of logic hardware.

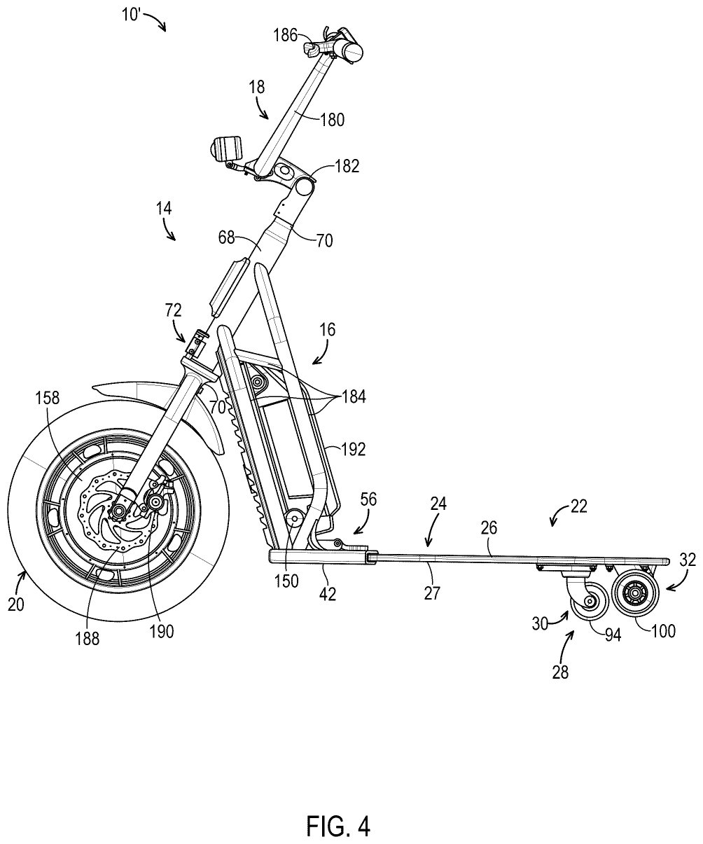

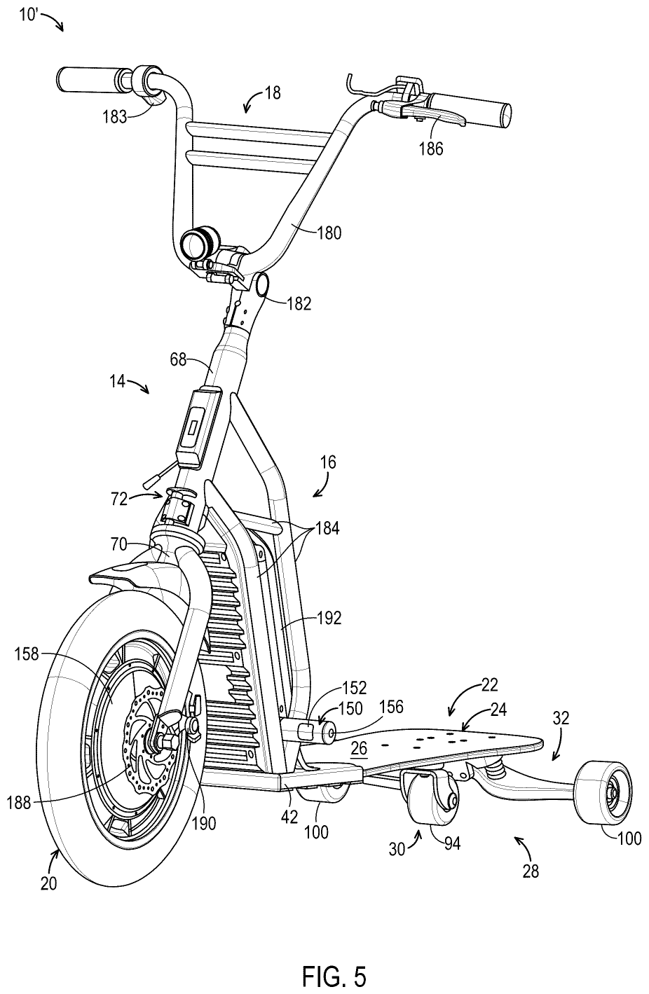

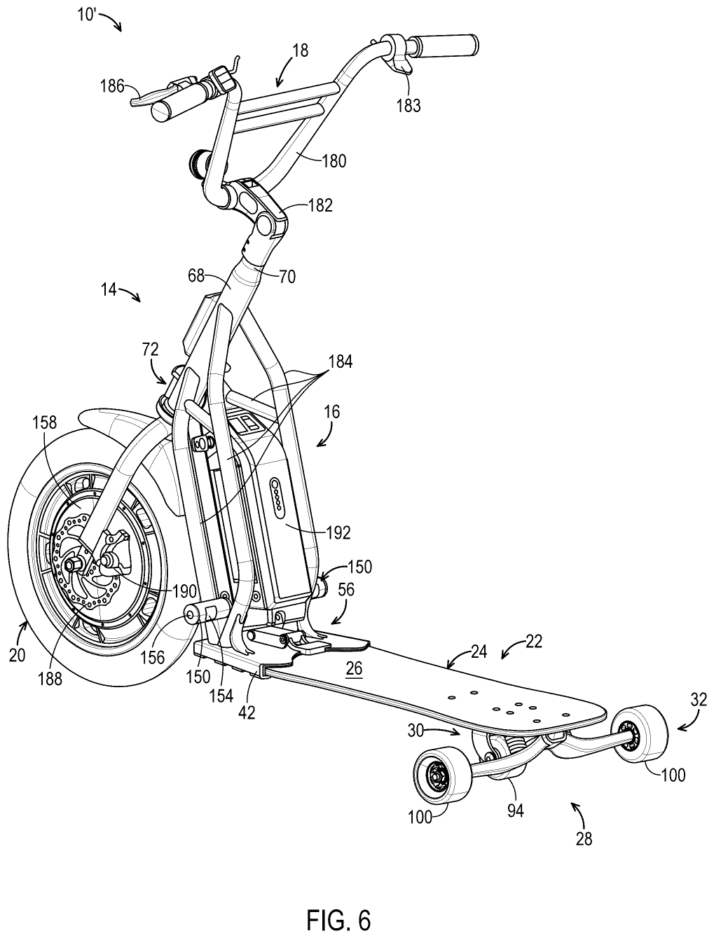

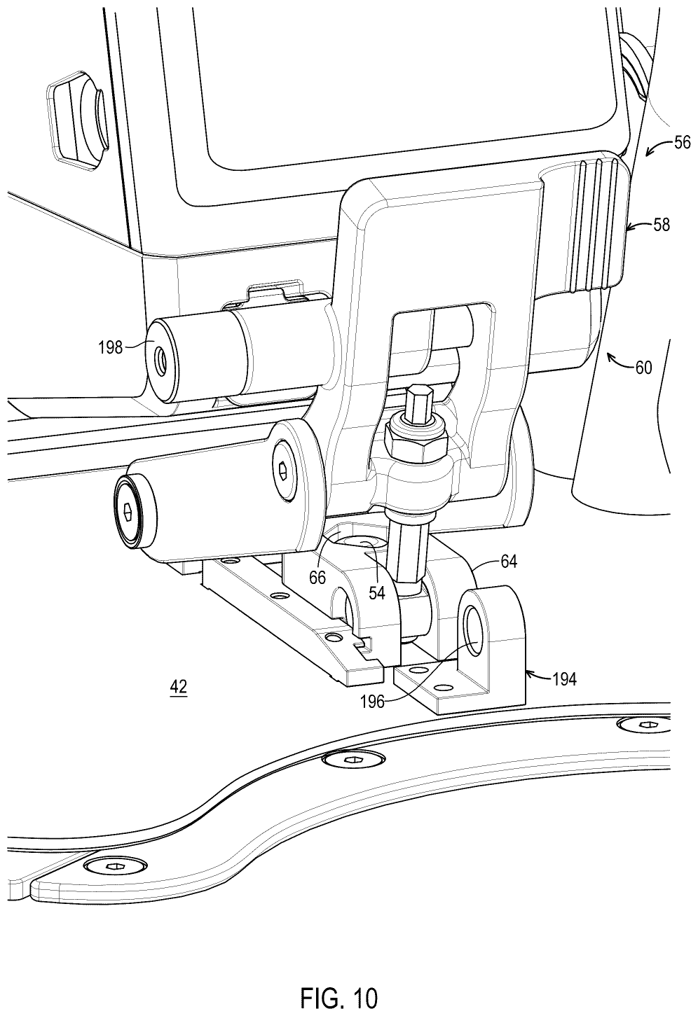

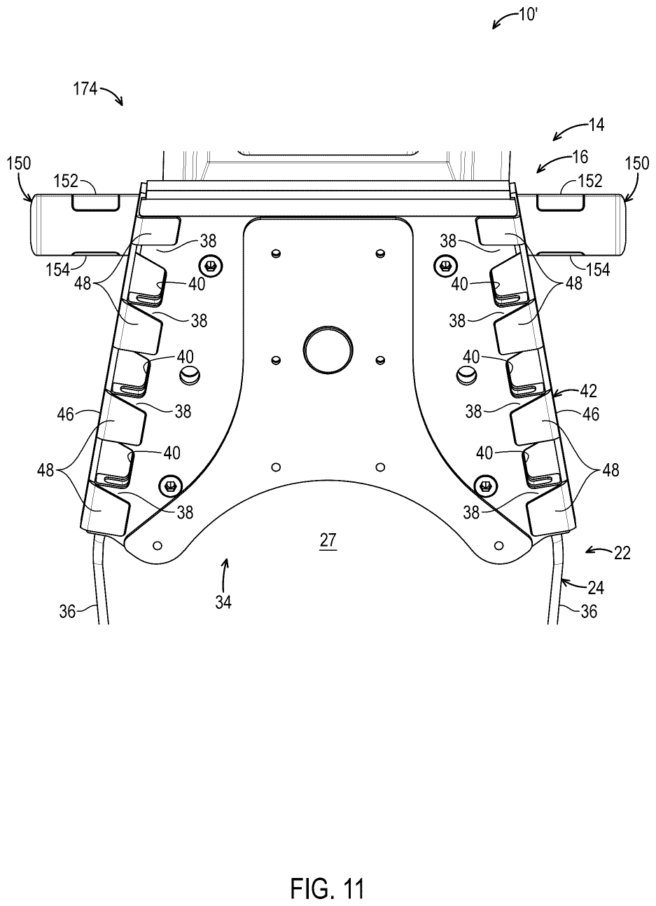

Turning now to FIGS. 4-26, illustrative non-exclusive examples of vehicles 10 and components thereof, including rearward assemblies 22, decks 24, and truck wheels 100 are illustrated. Where appropriate, the reference numerals from the schematic illustrations of FIGS. 1-3 are used to designate corresponding parts of the embodiments of FIGS. 4-26; however, the embodiments of FIGS. 4-26 are non-exclusive and do not limit the present disclosure to these illustrated embodiments. That is, vehicles 10 and the various components discussed herein may incorporate any number of the various aspects, configurations, characteristics, properties, etc. that are illustrated in and discussed with reference to the schematic representations of FIGS. 1-3 and/or the embodiments of FIGS. 4-26, as well as variations thereof, without requiring the inclusion of all such aspects, configurations, characteristics, properties, etc. For the purpose of brevity, each previously discussed component, part, portion, aspect, region, etc., or variants thereof may not be discussed, illustrated, and/or labeled again with respect to the embodiments of FIGS. 4-26; however, it is within the scope of the present disclosure that the previously discussed features, variants, etc. may be utilized with the embodiments of FIGS. 4-26.

Vehicle 10′ of FIGS. 4-17 is an example of a vehicle 10 whose rearward assembly 22 is selectively detachable from the forward assembly 14, whose rear wheel assembly 28 comprises a caster assembly 30 and a truck assembly 32, and whose front wheel 20 is powered with a hub motor 158. Accordingly, vehicle 10′ is an example of a drifting vehicle and generally comprises the various structures and features discussed above with respect to FIGS. 1-4, including a quick-disconnect assembly 56, a limiter 72, and frame sliders 150. Moreover, as best seen in FIGS. 4-6, the steering assembly 18 of vehicle 10′ comprises a stem 182 coupled to the steering tube 70 and handlebars 180 operably coupled to the stem 182. Front frame assembly 16 comprises frame members 184 operably coupled between the head tube 68 and a deck-receiving bracket 42. The forward assembly 14 of vehicle 10′ further comprises a throttle 183 and a brake lever 186 supported by the handlebars 180, a brake disc 188 operably coupled to the front wheel 20, a brake caliper 190 supported by the steering assembly 18, and a rechargeable battery pack 192 supported by the front frame assembly 16.

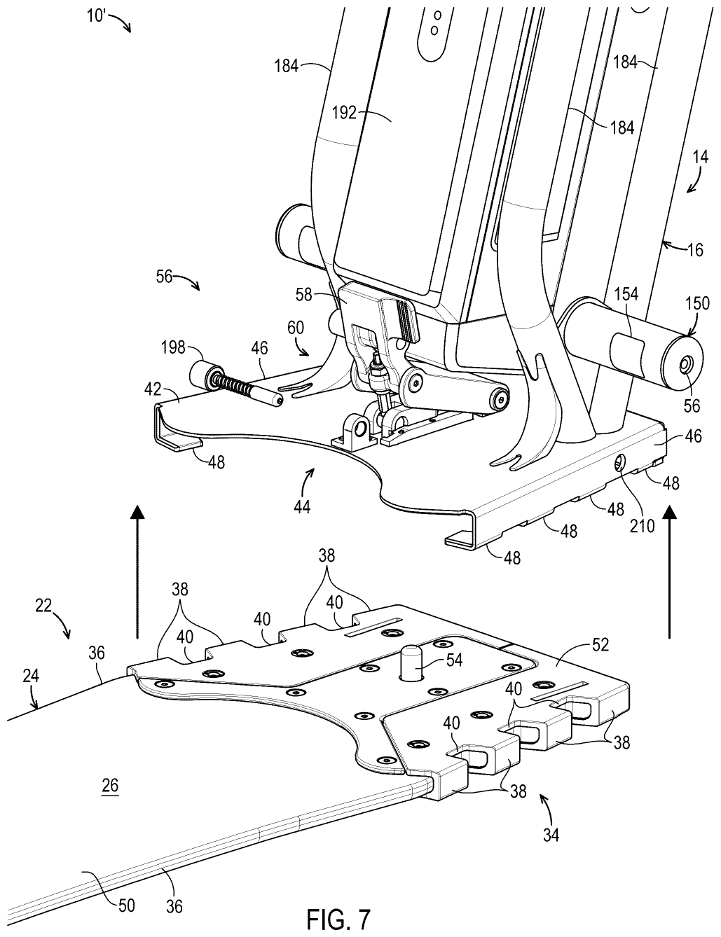

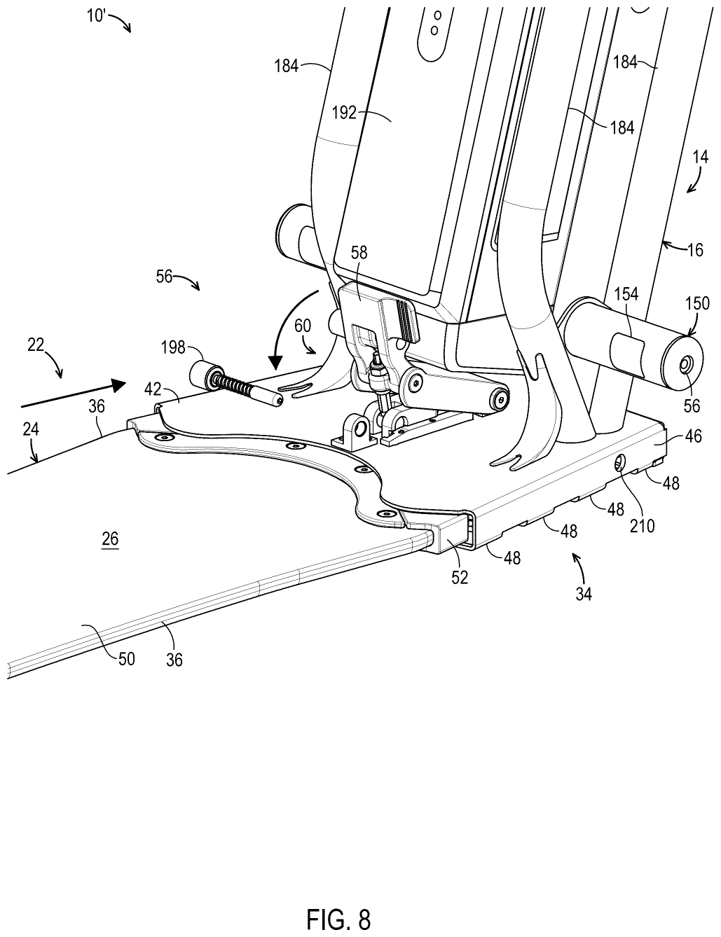

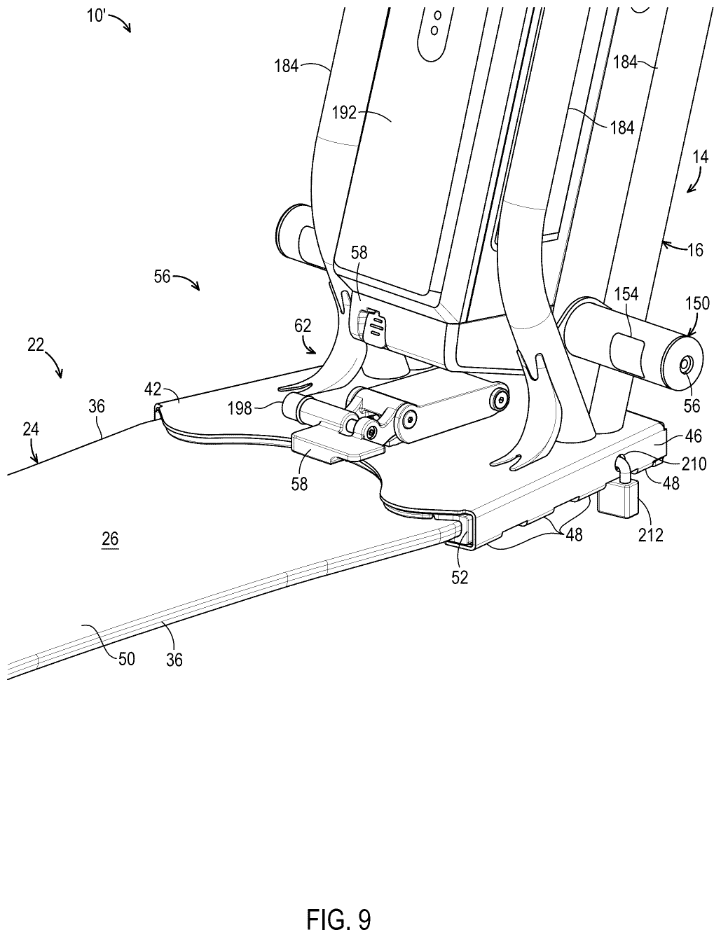

Turning to FIGS. 7-11, the forward assembly 14 and the rearward assembly 22 of vehicle 10′ collectively define a quick-disconnect assembly 56. The deck 24 of vehicle 10′ may be described as having a forward deck region 34 and lateral sides 36, and as best seen in FIG. 7, the deck 24 of vehicle 10′ comprises a plurality of protrusions 38 that extend from the lateral sides 36 within the forward deck region 34 and a plurality of notches 40 that extend into the lateral sides 36 within the forward deck region 34 between adjacent pairs of the plurality of protrusions 38. The forward assembly 14 of vehicle 10′ comprises a deck-receiving bracket 42 that is operably supported by the front frame assembly 16 and that defines a volume 44 that is configured to selectively receive the forward deck region 34. The deck-receiving bracket 42 comprises lateral sidewalls 46 and a plurality of retaining shelves 48 that extend medially from the lateral sidewalls 46. As seen in the sequence of FIGS. 7-9, the plurality of protrusions 38 are sized to selectively pass between the plurality of retaining shelves 48 for receipt of the forward deck region 34 into the volume 44 (FIG. 8) and then to selectively translate forward within the volume 44 for engagement by the plurality of retaining shelves 48 to operably retain the forward deck region 34 within the volume 44 (FIG. 9).

The deck 24 of vehicle 10′ comprises a main body 50 and a cap 52 that is operably coupled to the main body 50 within the forward deck region 34. The cap 52 defines the plurality of protrusions 38 and the plurality of notches 40. In vehicle 10′, the main body 50 and the cap 52 are constructed of different materials. In particular, the cap 52 is constructed of a more rigid and durable material than the main body 50 to permit for repeated translation into and within the volume 44 without undesirable degradation of the cap 52. Such a configuration maintains the integrity of the protrusions 38 and results in a desired longevity of the deck 24.

As seen in FIGS. 7 and 10, the deck 24 of vehicle 10′ further comprises a post 54 that extends from the upper side 26 of the deck 24 within the forward deck region 34. The post 54 is configured to be selectively engaged by the forward assembly 14 when the forward deck region 34 is operatively received in the volume 44 and the plurality of retaining shelves 48 are operably engaged with the plurality of protrusions 38 to operably maintain the forward deck region 34 in the volume 44. The forward assembly 14 of vehicle 10′ comprises a lever 58 that is positioned and configured to be engaged by a user. The lever 58 has an open position 60 (FIGS. 7, 8, and 10), in which the quick-disconnect assembly 56 permits the forward deck region 34 to be operably received and removed from the volume 44, and a closed position 62 (FIG. 9), in which the quick-disconnect assembly 56 restricts the forward deck region 34 from being removed from the volume 44 when the forward deck region 34 is operably received in the volume 44. The lever 58 is configured to be selectively locked in the closed position 62 to restrict transition to the open position 60.

As best seen in FIG. 10, the forward assembly 14 of vehicle 10′ further comprises a post block 64 that is operably coupled to the lever 58. The post block 64 defines an aperture 66 that is configured to receive and engage with the post 54 when the forward deck region 34 is received in the volume 44. The post block 64 is configured to translate the post 54 when the lever 58 transitions between the open position 60 (FIG. 8) and the closed position 62 (FIG. 9), thereby translating the forward deck region 34 forward within the volume 44.

As also best seen in FIG. 10, the lever 58 of vehicle 10′ is configured to be selectively locked in the closed position 62 (FIG. 9) to restrict transition to the open position 60 (FIG. 8). In particular, the quick-disconnect assembly 56 comprises a pin block 194 that is fixed relative to the deck-receiving bracket 42 and that defines a pin aperture 196. The lever 58 comprises a spring-biased pin 198 that is configured to selectively extend through the pin aperture 196 when the lever 58 is positioned in the closed position 62 (FIG. 9), thereby restricting the lever 58 from being pivoted away from the closed position 62 (FIG. 8).

As seen in FIGS. 7-9, the deck 24 may be operatively locked to the forward assembly 14. Specifically, a lock passage 210 is defined through the deck-receiving bracket 42, and through which a padlock 212 (FIG. 9) may be operatively extended and locked. When present, the padlock 212 obstructs the right, forward-most protrusion 38 of the deck 24 to prevent the deck 24 from translating rearward to align the protrusions 38 between the retaining shelves 48 of the deck-receiving bracket 42.

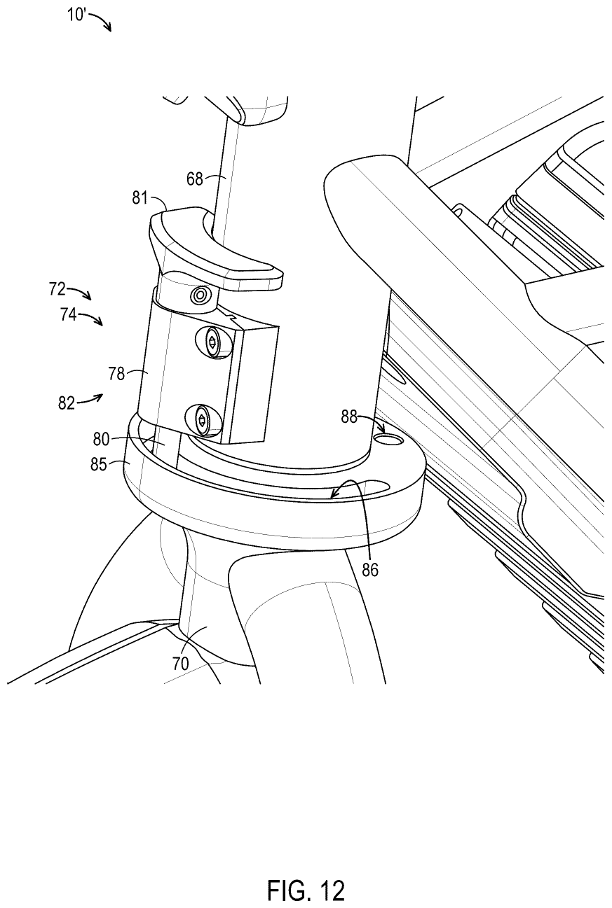

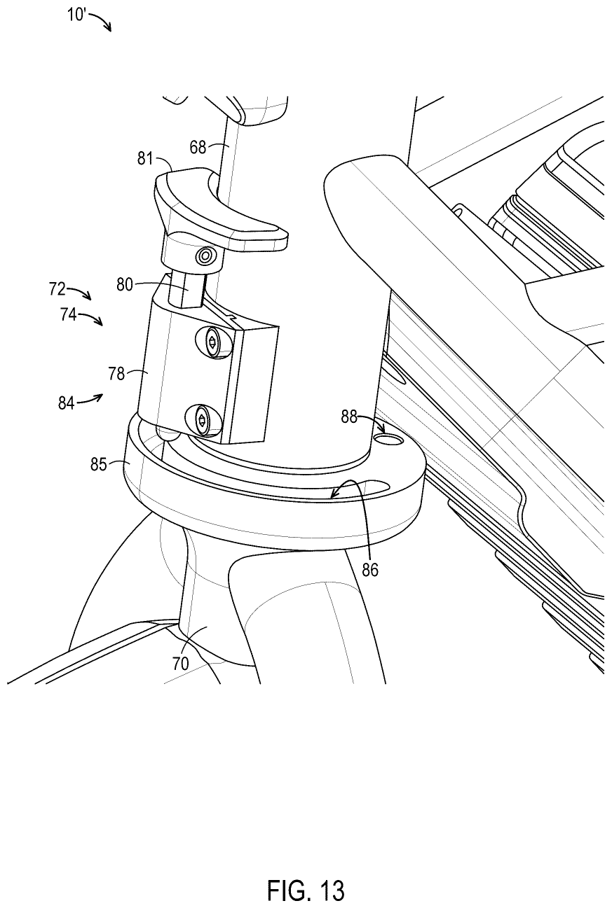

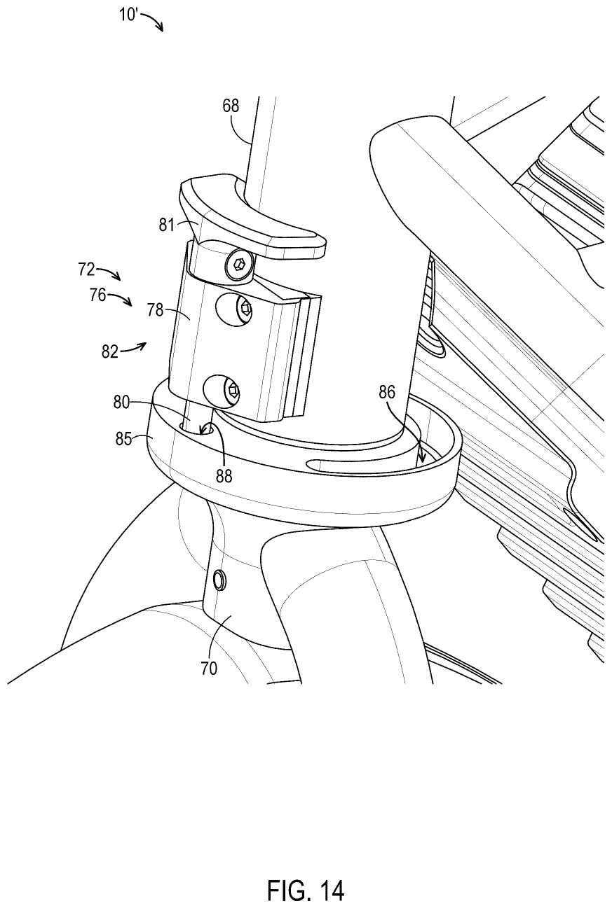

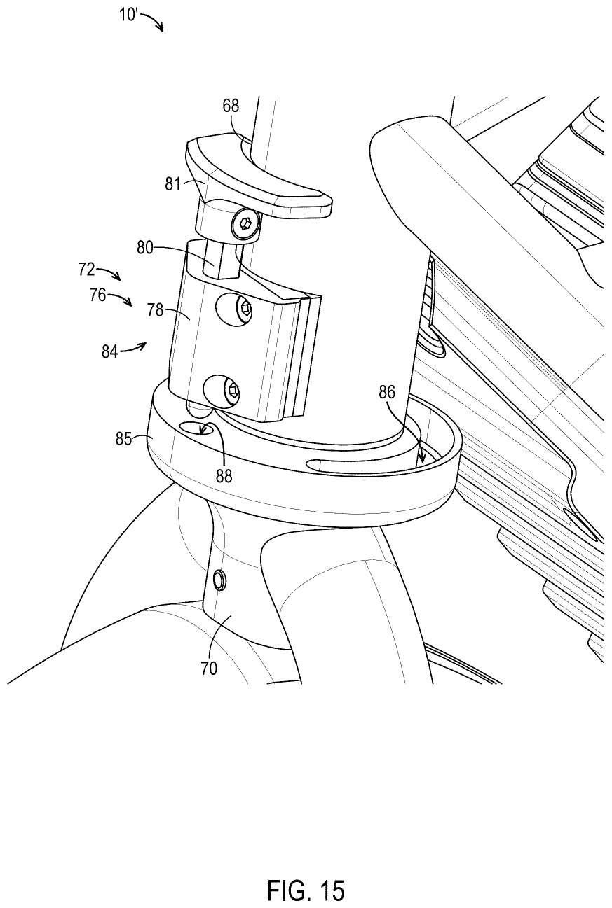

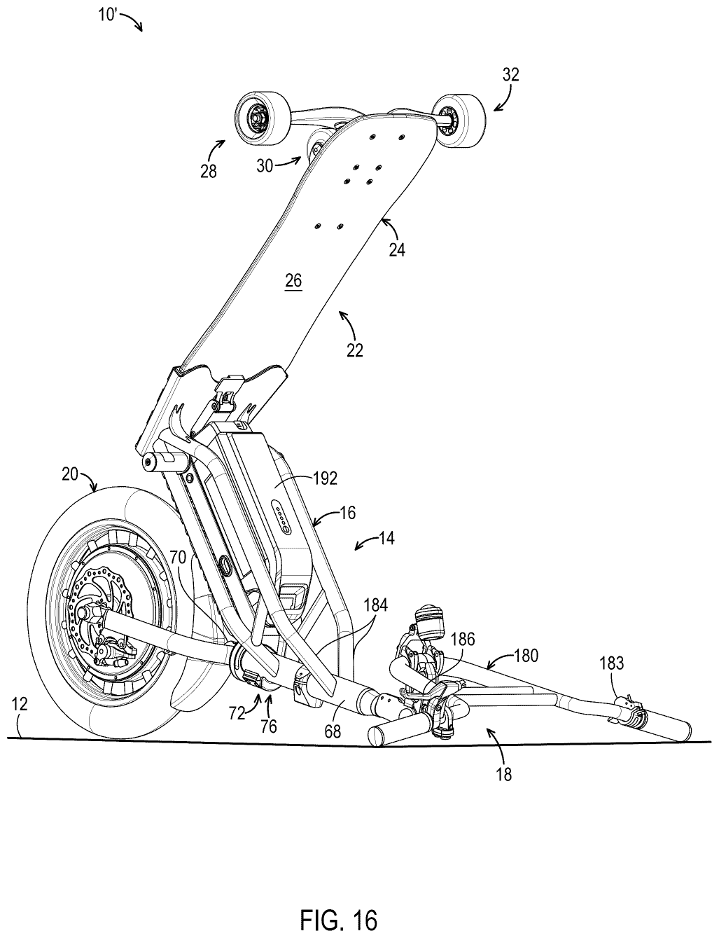

Turning now to FIGS. 12-15, the limiter 72 of vehicle 10′ has a first configuration 74 (FIG. 12), in which the steering tube 70 is limited to an angular range of rotation relative to the head tube 68, and a second configuration 76 (FIG. 14), in which the steering tube 70 is limited to no rotation relative to the head tube 68. The limiter 72 of vehicle 10′ comprises a limiter block 78 that is fixed to the head tube 68, and a limiter pin 80 that extends through the limiter block 78 and that is configured to be selectively translated between a locked position 82 (FIGS. 12 and 14) and an unlocked position 84 (FIGS. 13 and 15). The limiter pin 80 comprises a handle 81 for engagement by a user and is spring-biased toward the locked position 82. The limiter 72 of vehicle 10′ further comprises a circumferential flange 85 that extends around and is fixed relative to the steering tube 70. The circumferential flange 85 defines an arcuate channel 86 and a locking hole 88. Each of the arcuate channel 86 and the locking hole 88 are configured to be selectively aligned (via rotation of the steering tube 70) with the limiter pin 80 for receipt of the limiter pin 80 in the locked position 82 (FIGS. 12 and 14). The limiter 72 is in the first configuration 74 when the limiter pin 80 is received in the arcuate channel 86 (FIG. 12) and is in the second configuration 76 when the limiter pin 80 is received in the locking hole 88 (FIG. 14). As seen in FIG. 16, when the limiter 72 is in the second configuration 76, the vehicle 10′ may be placed in an inverted, self-standing position on a ground surface 12.

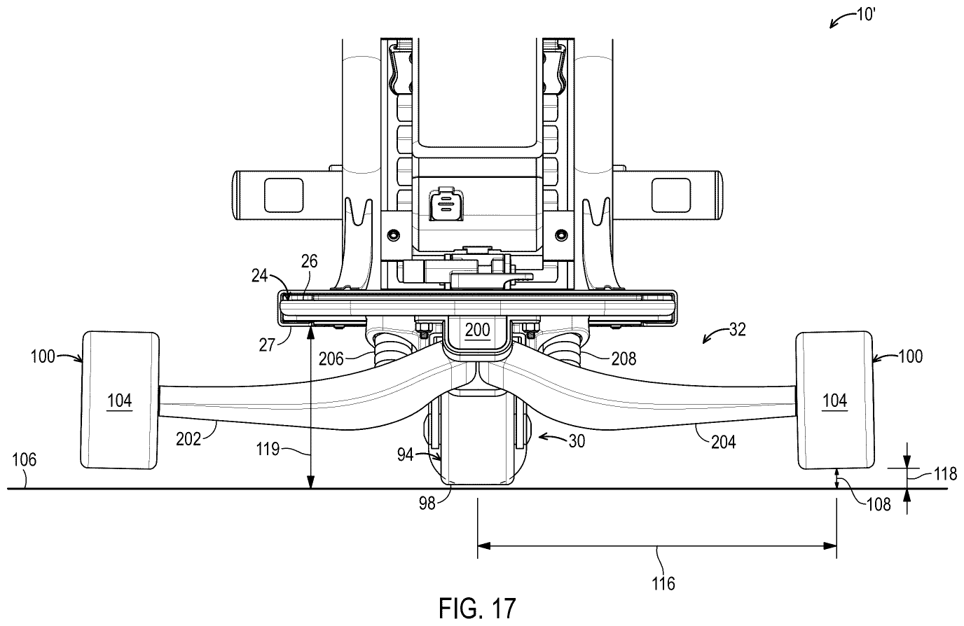

With reference now to FIG. 17, vehicle 10′ is depicted with (i) the front-wheel axis 90 and the caster-wheel axis 96 parallel to a planar ground surface 106, (ii) the front-wheel ground-contacting surface 92 and the caster-wheel ground-contacting surface 98 engaged with the planar ground surface 106, (iii) and the truck assembly 32 in the neutral configuration. In vehicle 10′, the truck-wheel angle 108 is about 1.2°, the truck-wheel track 116 is about 236 mm, the truck-wheel height 118 is about 10.7 mm, and the deck height 119 is about 111 mm.

The truck assembly 32 of vehicle 10′ is an example of a truck assembly 32 having an independent suspension configuration. Specifically, the truck assembly 32 of vehicle 10′ comprises a pivot block 200 mounted to the lower side 27 of the deck 24, a left axle 202 pivotally coupled to the pivot block 200 and operatively supporting the left truck wheel 100, a right axle 204 pivotally coupled to the pivot block 200 and operatively supporting the right truck wheel 100, a left spring 206 operatively positioned between the left axle 202 and the lower side 27 of the deck 24, and a right spring 208 operatively positioned between the right axle 204 and the lower side 27 of the deck 24. The left spring 206 and the right spring 208 bias the left axle 202 and the right axle 204, respectively, away from the lower side 27 of the deck 24.

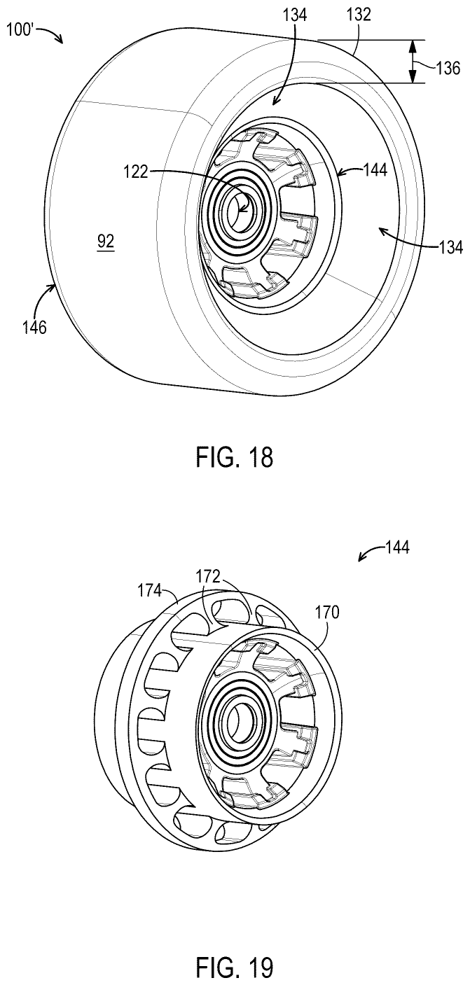

Truck wheel 100′ of FIGS. 18-20 is an example of a truck wheel 100 whose body 120 comprises a core 144 constructed of a plastic and a tire 146 constructed of a polyurethane that is molded over the core 144. The tire 146 of truck wheel 100′ has a lateral sidewall 132 and a frustoconical recess 134 that extends from the lateral sidewall 132 toward the axle bore 122 of the truck wheel 100′. In truck wheel 100′, the sidewall depth 136 is about 9 mm, the radius of curvature 138 is about 5 mm, the radius of curvature 142 is about 5 mm, and the bearing spacing 126 is about 15 mm.

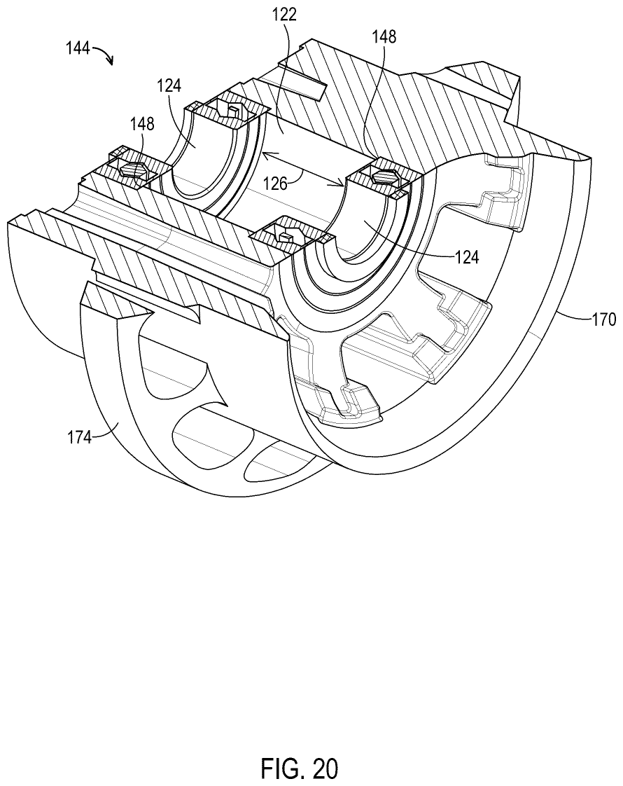

As seen in FIGS. 19 and 20, the core 144 comprises a cylindrical body 170, a plurality of outer splines 172 extending radially outward from the cylindrical body 170, and an annular ring 174 extending around and connecting the outer splines 172. The outer splines 172 and the annular ring 174 provide structure for secure over-molding of the tire 146 to the core 144.

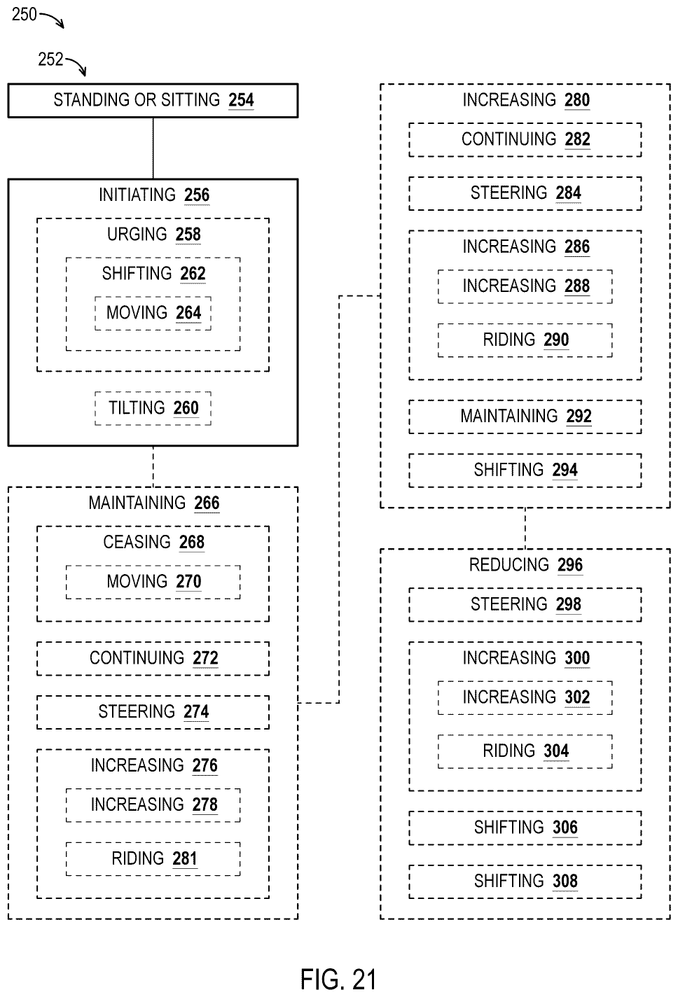

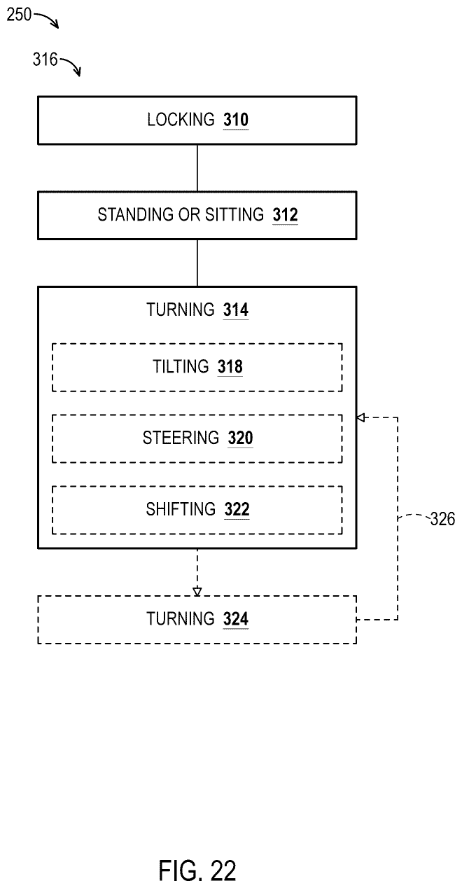

FIGS. 21 and 22 schematically provide flowcharts that represent illustrative, non-exclusive examples of methods 250 of riding vehicles 10. In FIGS. 21 and 22, some steps are illustrated in dashed boxes indicating that such steps may be optional or may correspond to an optional version of a method 250 according to the present disclosure. The methods 250 and steps illustrated in FIGS. 21 and 22 are not limiting and other methods and steps are within the scope of the present disclosure, including methods having greater than or fewer than the number of steps illustrated, as understood from the discussions herein.

Some methods 250 may be described as drifting on a vehicle 10, and some such methods may be described as carving (e.g., without drifting) on a vehicle 10. Because vehicles 10 are unique in their configuration with a caster assembly 30 and a truck assembly 32, and optionally with the front wheel 20 powered, riding vehicles 10 is not necessarily intuitive to individuals familiar with riding typical push scooters or e-scooters. The body movement necessary to initiate and control a drift on a vehicle 10 is very nuanced and takes significant practice to learn or feel-out. Generally, an individual never having ridden a vehicle 10 with a caster assembly 30 and a truck assembly 32 will not be able to perform controlled drifts without significant practice and possibly instruction from an experienced rider.

With reference first to FIG. 21, some methods 250 comprise standing or sitting 254 on the upper side 26 of the deck 24 of the vehicle. Some such methods 250 further comprise initiating 256 a drift in a drift direction. The initiating 256 comprises urging 258 the deck 24 to pivot relative to the steering assembly 18 in the drift direction. In some such methods 250, the urging 258 results in the caster wheel 94 pivoting to face the drift direction. Such methods 250 may be described as drifting on the vehicle or as drifting methods 252.

In some drifting methods 252, the urging 258 results in a first truck wheel 100 of the truck assembly 32 opposite the drift direction contacting and skidding on the ground surface 12 and a second truck wheel 100 of the truck assembly 32 opposite the first truck wheel 100 not contacting the ground surface 12.

In some drifting methods 252, the initiating 256 further comprises tilting 260 the deck 24 opposite the drift direction. In some such drifting methods 252, the tilting 260 comprises tilting the rider's foot or feet opposite the drift direction.

In some drifting methods 252, the urging 258 comprises shifting 262 the rider's center of gravity in the drift direction. In some such drifting methods 252, the shifting 262 comprises moving 264 the rider's hips in the drift direction.

Some drifting methods 252 further comprise maintaining 266 the drift in the drift direction, such as by ceasing 268 the urging 258. In some such drifting methods 252, the ceasing 268 comprises moving 270 the rider's shoulders opposite the drift direction. In some examples, the maintaining 266 the drift in the drift direction comprises continuing 272 to tilt the deck 24 opposite the drift direction. In some examples, the maintaining 266 further comprises steering 274 the front wheel 20 in the drift direction. In some examples, the maintaining 266 further comprises increasing 276 rotation of the front wheel 20. For example, the increasing 276 rotation may comprise increasing 278 power to the motor 158 and/or riding 281 the vehicle 10 down a steeper incline.

Some drifting methods 252 further comprise increasing 280 the drift in the drift direction. In some examples, the increasing 280 comprises continuing 282 to urge the deck 24 in the drift direction. In some examples, the increasing 280 comprises steering 284 the front wheel 20 opposite the drift direction. In some examples, the increasing 280 comprises increasing 286 rotation of the front wheel 20. For example, the increasing 286 rotation may comprise increasing 288 power to the motor 158 and/or riding 290 the vehicle 10 down a steeper incline. In some examples, the increasing 280 comprises maintaining 292 the rider's center of gravity in a position relative to the deck 24. In some examples, the increasing 280 comprises shifting 294 the rider's center of gravity further in the drift direction.

Some drifting methods 252 further comprise reducing 296 the drift. In some examples, the reducing 296 comprises steering 298 the front wheel 20 in the drift direction. In some examples, the reducing 296 comprises increasing 300 rotation of the front wheel 20, such as by increasing 302 power to the motor 158 and/or riding 304 the vehicle 10 down a steeper incline. In some examples, the steering 298 and the increasing 280 are performed simultaneously. In some examples, the reducing 296 comprises shifting 306 the rider's center of gravity toward the front wheel 20. In some examples, the reducing comprises shifting 308 the rider's center of gravity away from the drift direction.

Turning now to FIG. 22, some methods 250 comprise locking 310 the caster assembly 30 with the caster wheel 94 aligned with the deck 24 to restrict pivoting of the caster wheel 94, standing or sitting 312 On the upper side 26 of the deck 24, and turning 314 the vehicle 10 in a turn direction without drifting. Such methods 250 may be described as methods of carving on the vehicle or as carving methods 316.

In some carving methods 316, the turning 314 comprises tilting 318 the deck 24 in the turn direction. In some such examples, the tilting 318 results in a first truck wheel 100 of the truck assembly 32 on a side of the truck assembly 32 corresponding to the turn direction contacting the ground surface 12 and a second truck wheel 100 of the truck assembly 32 opposite the first truck wheel 100 not contacting the ground surface 12.

In some carving methods 316, the turning 314 comprises steering 320 the front wheel 20 in the turn direction. In some such examples, the steering 320 is initiated simultaneously with or immediately following (e.g., within one second, within half a second, or within a quarter of a second of) initiation of the tilting 318. In some carving methods 316, the turning 314 comprises shifting 322 the rider's center of gravity in the turn direction. In some such examples, the shifting 322 is initiated simultaneously with or immediately following (e.g., within one second, within half a second, or within a quarter of a second of) the initiating of the tilting 318. In some examples, the shifting 322 is initiated simultaneously with or immediately following (e.g., within one second, within half a second, or within a quarter of a second of) initiation of the steering 320.

In some carving methods 316, the turn direction is a first turn direction, and the carving method 316 further comprises following the turning 314 the vehicle 10 in the first turn direction, turning 324 the vehicle 10 in a second turn direction opposite the first turn direction. Some such carving methods 316 further comprise repeating 326 the turning the vehicle 10 in the first turn direction and the turning the vehicle 10 in the second turn direction.

Also within the scope of the present disclosure are systems 350 and associated methods for operating, managing, tracking, monitoring, gamifying, and/or otherwise adding functionality to a network of individuals participating in recreational activities. While these recreational activities may be associated with vehicles 10 and methods 250 according to the present disclosure, they are not required to be. That is, the systems and methods disclosed below are equally applicable to, and may be implemented with, any suitable recreational activity and structure associated therewith (e.g., sport boards, skis, other vehicles, etc.).

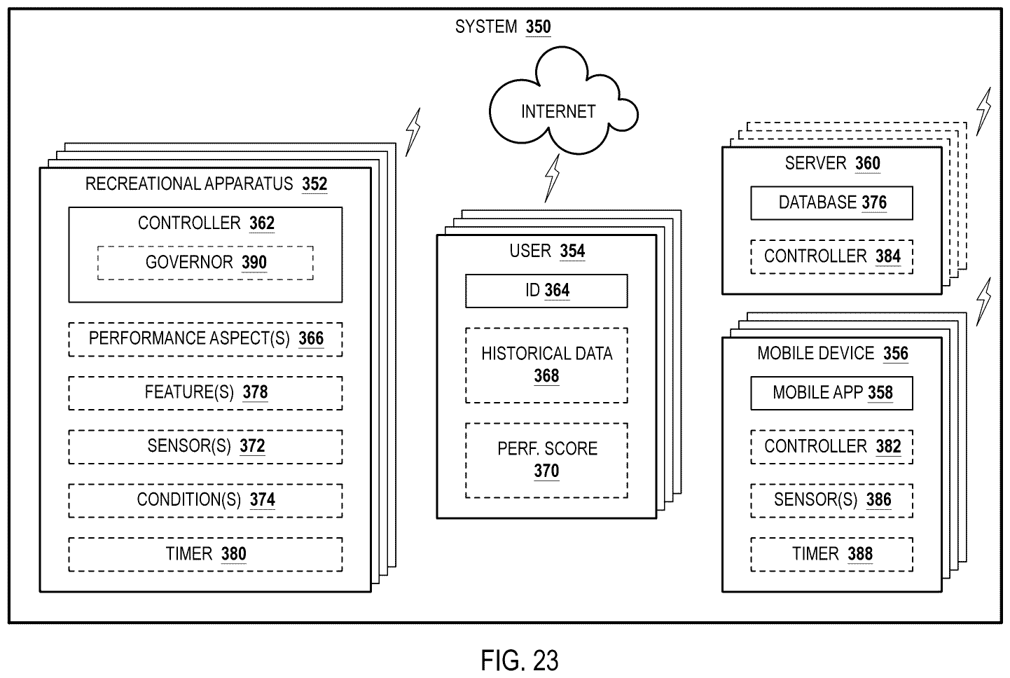

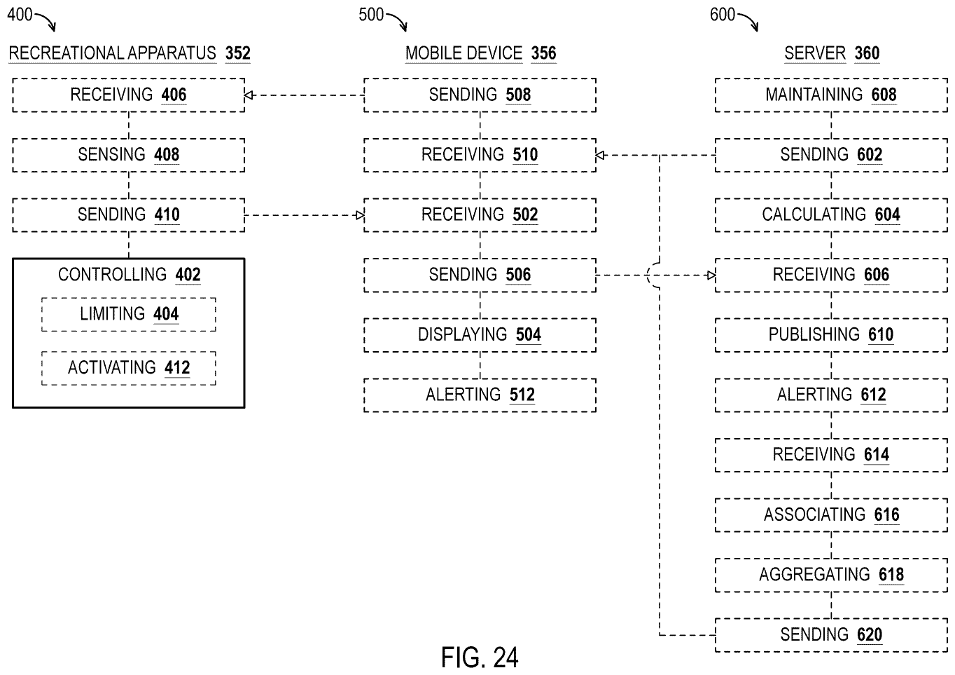

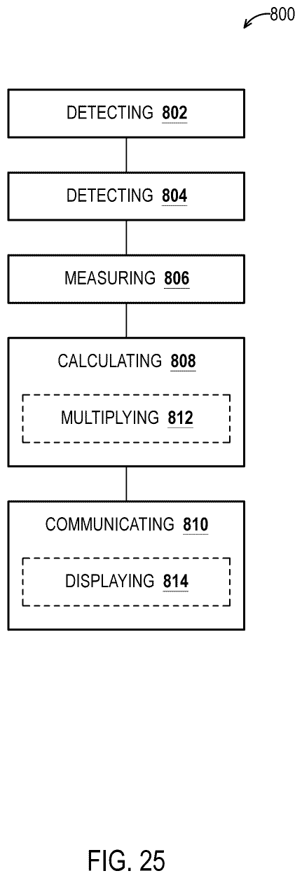

FIG. 23 schematically represents recreational activity systems 350. As schematically represented, recreational activity systems 350 may comprise and/or interact with one or more of a plurality of recreational apparatuses 352 (e.g., vehicles 10), a plurality of users 354, a plurality of mobile devices 356 (e.g., smart phones, wearables, etc.) running mobile applications 358 and associated with the plurality of users 354, and one or more servers 360. FIGS. 24 and 25 schematically present methods associated with systems 350, including methods 400 performed by or on a recreational apparatus 352, methods 500 performed by or on a mobile device 356, methods 600 performed by or on a server 360, and methods 700, which may be performed by or on any suitable device, including a recreational apparatus, a mobile device 356, a server, or a combination thereof. These methods additionally or alternatively may be described as recreational activity methods. In FIGS. 24 and 25, some steps are illustrated in dashed boxes indicating that such steps may be optional or may correspond to an optional version of a method according to the present disclosure. The methods and steps illustrated in FIGS. 24 and 25 are not limiting, and other methods and steps are within the scope of the present disclosure, including methods having greater than or fewer than the number of steps illustrated, as understood from the discussions herein.

The recreational apparatuses 352 typically comprise some form of controller 362 (e.g., computer hardware, software, and/or firmware) configured to control and detect aspects of the respective recreational apparatus 352 (e.g., speeds, angles, locations, durations, battery condition, etc.), to save data associated with such aspects, and to communicate (i.e., send and receive) such data to and from external devices (e.g., via wireless communication), such as mobile devices 356 and/or servers 360. Recreational apparatuses 352 may include recreational vehicles, such as vehicles 10 according to the present disclosure, but also may include any other suitable recreational apparatuses or hardware.

The mobile device 356 and the server(s) 360 also comprise controllers 382, 384 configured to perform the functions and methods described herein. The controllers 362, 382, 384 of the recreational apparatuses 352, the mobile devices 356, and the server(s) 360 may include any suitable device or devices that are configured to perform the functions discussed herein. For example, the controllers may include one or more of an electronic controller, a dedicated controller, a special-purpose controller, a special-purpose computer, a display device, a logic device, a memory device, and/or a memory device having non-transitory computer-readable media suitable for storing computer-executable instructions for implementing methods according to the present disclosure.

With reference to FIG. 23, a recreational apparatus 352 of a recreational activity system 350 typically comprises at least a controller 362 that is configured to control aspects of the recreational apparatus 352 based at least in part on an identification 364 (e.g., a unique identifier or ID, such as an alphanumeric string of characters, a user logon, a username, a user ID, etc.) of a particular user 354 of the recreational apparatus 352. Accordingly, with reference to FIG. 24, methods 400 implemented by or on a recreational apparatus 352 may comprise controlling 402 aspects of the recreational apparatus 352 based at least in part on the identification 364 of a particular user 354 of the recreational apparatus 352.

In some examples, the controller 362 of a recreational apparatus 352 is configured to limit one or more performance aspects 366 of the recreational apparatus 352 (e.g., speed of a vehicle) based at least in part on the identification 364 of the particular user 354. For example, as schematically represented in FIG. 23, the controller 362 may comprise a governor 390 that is configured to limit the speed of the recreational apparatus 352.

Additionally or alternatively, the controller 362 may be configured to activate, or control activation of, one or more features 378 of the recreational apparatus 352 based at least in part on the identification 364 of the particular user 354. Similarly, in some methods 400, the controlling 402 comprises limiting 404 (e.g., setting, inhibiting, disabling, etc.) one or more performance aspects 366 of the recreational apparatus 352 and/or activating one or more features 378 of the recreational apparatus 352 based at least in part on historical data 368 associated with the particular user 354.

An example of a performance aspect 366 that may be limited by the controller 362 and/or as a result of a method 400 includes a maximum speed permitted by the recreational apparatus 352. Examples of features 378 that may be actuated by the controller 362 and/or as a result of a method 400 include physical features, visual features, and/or audible features. For example, a recreational apparatus 352 may comprise lights or lamps (e.g., LEDs) that are configured to emit different colors depending on the particular user 354 using the recreational apparatus 352. For example, users 354 with a higher performance score 370 (discussed below) may cause the lights to emit a specific color, while users 354 with a lower performance score 370 may cause the lights to emit a different specific color. Accordingly, the ability levels of users 354 of recreational apparatuses 352 may be communicated to viewers. Similar functionality may be implemented with audible characteristics of the recreational apparatus 352 or any other suitable feature thereof.

Some methods 400 further comprise receiving 406 from a mobile device 356 data associated with the historical data 368, with the limiting 404 being based at least in part on the data received from the mobile device 356. Similarly, some methods 500 comprise sending 508 to the recreational apparatus 352 data (e.g., a performance score 370) associated with historical data 368 of a particular user 354 of the recreational apparatus 352. Some such methods 500 further comprise receiving 510 from a server 360 the data associated with the historical data 368 of the particular user 354 of the recreational apparatus 352.

Some methods 500 further comprise alerting 512 the particular user 354 of a notification based at least in part on the historical data 368 of the particular user 354. The notification may include any suitable information associated with the user 354 and/or a recreational apparatus 352. As an example, an alert may notify a user 354 when a component of the recreational apparatus 352 is likely needed to be replaced or serviced, based on one or more criteria. For example, after a recreational apparatus 352 has been used for a threshold period of time or has been ridden a threshold distance, some components may need to be serviced and/or replaced. Using a vehicle 10 as an illustrative example, a truck wheel 100 that has experienced a threshold number of drifts or powerslides may qualify as likely to need replacement. As another example, bearings of wheels may need to be replaced or lubricated after a certain (cumulative) distance of travel. Lightbulbs or LEDs may need to be replaced after a duration of illumination. Other features and aspects of recreational apparatuses 352 also may be associated with data that results in an alert by a mobile device.

Methods 600 implemented by a server 360 may comprise sending 602 to a mobile device 356 data (e.g., a performance score 370) associated with historical data 368 of a particular user 354 of any one of a plurality of recreational apparatuses 352. Some methods 600 further comprise calculating 604 the data associated with the historical data 368 of the particular user 354. Some methods 600 further comprise receiving 606 from the mobile device 356 data associated with one or more conditions 374 sensed by the plurality of recreational apparatuses 352 when operated by the particular user 354, with the historical data 368 comprising the data associated with the one or more conditions 374. Some methods 600 further comprise maintaining 608 a database 376 of data associated with historical data 368 of a plurality of users 354 of the plurality of recreational apparatuses 352.

In some examples, the historical data 368 may comprise data associated with the particular user 354 (e.g., identification 364) using any one of a plurality of recreational apparatuses 352. That is, the historical data 368 is associated with the specific user 354 and not a specific recreational apparatus 352. Accordingly, the historical data 368 “follows” the user 354 regardless of whether the particular user 354 owns, is sharing, is borrowing, is renting, or otherwise just trying (e.g., test riding) a recreational apparatus 352. This historical data 368 may be saved and stored on a mobile device 356 and/or on a server 360, with the controller 365 of the recreational apparatus 352 being configured to communicate with the mobile device 356 and/or the server 360 for implementation of the limitations on one or more performance aspects 366.

As examples, the historical data 368 may comprise one or more of a cumulative distance the particular user 354 has ridden a recreational apparatus 352, a (cumulative) duration the particular user 354 has used a particular recreational apparatus 352, identification of maneuvers performed by the particular user 354 on a recreational apparatus 352, or a performance score 370 associated with the particular user 354.

Performance scores 370 may be based on any number of suitable criteria. For example, performance scores 370 may be based at least in part on one or more of difficulty levels assigned to specific maneuvers on a recreational apparatus 352 (e.g., the more difficult a maneuver, the higher the weighting in the performance score 370 for that particular maneuver), a cumulative distance a particular user 354 has ridden a recreational apparatus 352 (e.g., the greater the distance, the higher the weighting in the performance score 370), the cumulative duration the particular user 354 has used a recreational apparatus 352 (e.g., the longer the duration, the higher the weighting in the performance score 370), the speed at which the particular user 354 performs a specific maneuver (e.g., the faster the speed, the higher the weighting in the performance score 370), the identification of maneuvers performed by the particular user 354 on a recreational apparatus 352, or a (cumulative) quantity of particular maneuvers performed by the particular user 354 on a recreational apparatus 352 (e.g., a number of more difficult maneuvers may be weighted greater than a number of easier maneuvers in the performance score).

Using vehicles 10 as an example, the maneuvers affecting the performance score 370 and/or otherwise comprising the historical data 368 of a user 354 may comprise one or more of drifts, spins, drift angles, carving, jumps, or reverses (e.g., riding goofy when normally regular or riding regular when normally goofy). Using speed as an example limitation implemented by a controller 362 of a recreational apparatus 352, the recreational apparatus 352 may be limited to a first threshold speed (e.g., 10 miles per hour (mph)) until the particular user 354 has ridden a recreational apparatus 352 for a threshold duration (e.g., ten hours). In response to the user 354 having ridden a recreational apparatus 352 for the threshold duration, the recreational apparatus 352 may be limited to a second, higher threshold speed (e.g., 20 mph). That is, the second threshold speed may be “unlocked” only after the user 354 has spent a considerable amount of riding time on a recreational apparatus 352. Then, perhaps the speed of a recreational apparatus 352 ridden by the user 354 is limited to a third threshold speed (e.g., 30 mph) until a certain number of successful drifts or spins have been accomplished by the user 354, or perhaps a certain degree of drifts (e.g., greater angle of the deck 24 relative to the front wheel 20) have been successfully accomplished by the user 354.

Performance scores 370 may be used in a variety of ways, such as by keeping and publishing a scoreboard and/or awarding awards when threshold performance scores 370 are achieved. That is, a method 600 may comprise publishing 610 information associated with recreational apparatuses 352 and/or users 354, including performance scores 370, a scoreboard, and/or awards (virtual or otherwise).

As another example, a threshold performance score 370 may “unlock” a discount for future products or for replacement parts or consumable parts. Using vehicles 10 again as an example, a first threshold performance score 370 may result in a discount on replacement truck wheels 100 and a second, higher threshold performance score 370 may result in free replacement truck wheels 100. Accordingly, users 354 are incentivized to increase their performance score 370.

In some recreational activity systems 350, a server 360 is configured to communicate with a plurality of recreational apparatuses 352 to receive data from the plurality of recreational apparatuses 352, and associate the data received by the server 360 to individual users 354 of the plurality of recreational apparatuses 352 regardless of which one of the plurality of recreational apparatuses 352 an individual user 354 used. In other words, with reference to FIG. 24, some methods 600 comprise receiving 614 data from a plurality of recreational apparatuses 352 and associating 616 the data received from the plurality of recreational apparatuses 352 with individual users 354 of the plurality of recreational apparatuses 352 regardless of which one of the plurality of recreational apparatuses 352 an individual user 354 used. Accordingly, a particular user's data may be agnostic as to which recreational apparatus 352 of the plurality of recreational apparatuses 352 the particular user 354 uses. That is, as discussed above, the data of a particular user 354 may be said to “follow” the user 354 regardless of whether the particular user 354 owns, is sharing, is borrowing, is renting, or otherwise just trying (e.g., test riding) a recreational apparatus 352. Similarly, a particular user 354 may loan their recreational apparatus 352 to another user 354 without the particular user's 354 data (e.g., historical data 368) being corrupted or otherwise mixed with the data of the user borrowing the recreational apparatus 352.

In particular, in some recreational activity systems 350, the server 360 is further configured to aggregate the data associated with each individual user 354 across multiple ones of the plurality of recreational apparatuses 352. Stated differently and with reference to FIG. 24, some methods 600 further comprise aggregating 618 the data associated with each individual user 354 across multiple ones of the plurality of recreational apparatuses 352. In some recreational activity systems 350, the server 360 is further configured to send instructions to an individual recreational apparatus 352 of the plurality of recreational apparatuses 352 being used by a particular user 354, with the instructions being based at least in part on the data received from the plurality of recreational apparatuses 352 associated with the particular user 354. That is, some methods 600 further comprise sending 620 instructions to an individual recreational apparatus 352 of the plurality of recreational apparatuses 352 being used by a particular user 354. In some examples, the instructions are configured to control aspects of the individual recreational apparatus 352. As schematically represented in FIG. 24, in some examples, the instructions are sent to a mobile device 356 associated with the particular user 354 for delivery to the individual recreational apparatus 352. In some examples, the instructions are configured to control aspects of the individual recreational apparatus 352.

For example, as discussed herein, the instructions may be configured to limit one or more performance aspects 366 of the individual recreational apparatus 352, and/or activate one or more performance aspects 366 of the individual recreational apparatus 352.

With reference back to FIG. 23, some recreational apparatuses 352 further comprise one or more sensors 372 that are configured to detect (or measure or sense) one or more conditions 374 associated with the recreational apparatus 352. In such recreational apparatuses 352, the controller 362 is configured to communicate the conditions 374 (e.g., to a mobile device 356 operating a mobile application 358 or to a server 360 for association with a particular user 354) (e.g., to be associated with the identification 364 of the user 354). Accordingly, as schematically represented in FIG. 24, some methods 400 further comprise sensing 458 one or more conditions 374 associated with the recreational apparatus 352, and sending 410 to a mobile device 356 data associated with the one or more conditions 374 for association with the identification 364 of the particular user 354. Similarly, methods 500 comprise receiving 502 from a recreational apparatus 352 data associated with the conditions 374 sensed by the recreational apparatus 352.

Additionally or alternatively, mobile devices 356 may comprise one or more sensors 386 configured to detect (or measure or sense) one or more conditions 374 associated with the recreational apparatus 352, when a mobile device 356 is operatively coupled to, attached to, mounted on, or otherwise carried by an associated recreational apparatus 352. Accordingly, a recreational apparatus 352 may be configured to have a mobile device 356, such as a smart phone, mounted thereto with the sensor(s) 386 of the mobile device 356 effectively sensing conditions associated with the recreational apparatus 352.

These conditions 374 may be associated with particular maneuvers that affect the limitations imposed on the controller 362 on a recreational apparatus 352 and/or that affect a performance score 370 of the particular user 354 of the recreational apparatus 352.

As examples, these one or more conditions may comprise an angular velocity of a component of the recreational apparatus 352; an angular displacement of a component of the recreational apparatus 352; a speed of the recreational apparatus 352; a speed of a component of the recreational apparatus 352; an acceleration of the recreational apparatus 352; an acceleration of a component of the recreational apparatus 352; a rotational speed of one or more wheels of the recreational apparatus 352; or a location of the recreational apparatus 352.

In some examples of recreational apparatuses 352, the one or more sensors 372 comprise one or more of a speedometer, a light-based sensor, a camera, a Global Navigation Satellite System (GNSS) sensor, an inertial measurement unit, an accelerometer, a radar sensor, a lidar sensor, or a potentiometer. In the example of vehicles 10, a sensor 372 may be a sensor 160 discussed above. In some examples of mobile devices 356, the one or more sensors 386 comprise one or more of a GNSS sensor, an inertial measurement unit, an accelerometer, or a compass sensor. Additionally, as schematically represented in FIG. 23, recreational apparatuses 352 may comprise a timer 380 and/or mobile devices 356 may comprise a timer 388 configured to measure a time duration associated with the conditions 374 and thus with a maneuver performed by or on the recreational apparatus 352.

Some methods 500 further comprise displaying 504 the data (e.g., on a display device of the mobile device 356) associated with the one more conditions 374 sensed by the recreational apparatus 352. Some methods 500 further comprise sending 506 to a server 360 the data associated with the one or more conditions 374 sensed by the recreational apparatus 352, such as for saving in the database 376 and being used to calculations performed by the server 360.

Turning now to FIG. 25, but with continued reference to FIG. 23, methods 800 may be described as methods of scoring, or rating, maneuvers performed by a user of a recreational apparatus 352, such as a vehicle 10, which methods may be performed by a recreational activity system 350. As schematically represented in FIG. 25, methods 800 comprise detecting (or sensing) 802 a speed of a recreational apparatus 352, detecting (or sensing) 804 a specific maneuver of the recreational apparatus 352, measuring 806 a time interval that the specific maneuver is performed, calculating 808 a score based on a speed-value associated with the specific maneuver at the speed and an interval-value associated with the time internal, and communicating 810 the score. The calculated score may subsequently be used to calculate a performance score 370 according to the present disclosure.

Correspondingly, as schematically represented in FIG. 23, some recreational activity systems 350 comprise sensors that are configured to detect (i) a speed of a recreational apparatus 352, and (ii) a specific maneuver of the recreational apparatus 352; a timer that is configured to measure a time interval that the specific maneuver is performed by the recreational apparatus 352; and a controller of the recreational apparatus 352, a mobile device 356, or a server 360 that is programmed to calculate a score based on a speed-value associated with the specific maneuver at the speed and an interval-value associated with the time interval, and communicate the score.

The sensors and the timer may be components of the recreational apparatus 352 itself, indicated as sensor(s) 372 and timer 380 in FIG. 23, and/or the sensors and the timer may be components of a mobile device 356, indicated as sensor(s) 386 and timer 388 in FIG. 23. The controller that calculates the score may be a component of the recreational apparatus 352, the mobile device 356, or a server, indicated respectively in FIG. 23 as controller 362, controller 382, and controller 384.

In some methods 800 and recreational activity systems 350, the specific maneuver is one of a plurality of maneuvers, and each maneuver of the plurality of maneuvers has distinct speed-values associated with it.

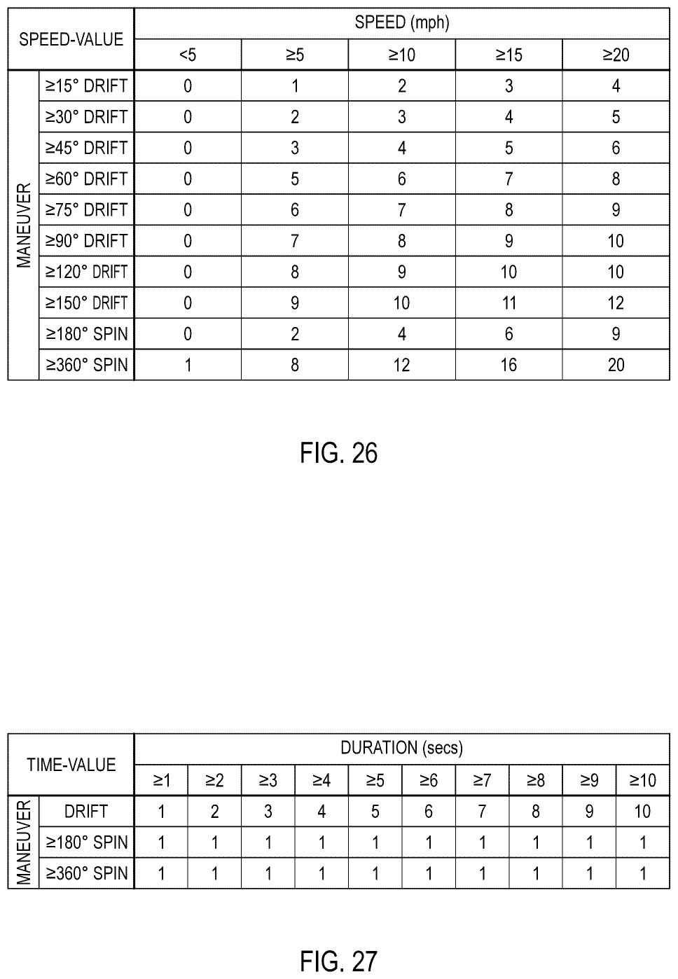

Using a drifting vehicle 10 as an example recreational apparatus 352, in some examples, the plurality of maneuvers comprise a plurality of drifts, wherein each drift of the plurality of drifts has a distinct angle of drift, or range of angles. In some examples, the plurality of maneuvers comprises a plurality of spins, wherein each spin of the plurality of spins has a distinct angle of spin, or range of angles of spin. For example, FIGS. 26 and 27 provide tables of example speed-values and time-values, respectively, that may be used to calculate the score associated with specific maneuvers performed on a drifting vehicle 10. In particular, with reference to FIG. 26, ten specific maneuvers, including eight drifts of various threshold angles and two spins of various threshold angles, are identified together with five threshold speeds. For example, the angle of a drift or spin of the vehicle 10 may be sensed and the speed at which the maneuver was performed may be detected. The speed may be determined at the initiation of the maneuver, at the completion of the maneuver, or may be based on an average speed over the duration of the maneuver. As shown in FIG. 26, although not required in all examples, the speed-value increases as the difficulty of the maneuver increases and as the speed increases.

With reference to FIG. 27, three maneuvers, including a drift and two spins, are identified with ten threshold time intervals, or durations. For example, the longer a specific maneuver is performed, the higher the time-value may be, such as indicated in the example of a drift being performed. However, some maneuvers may not be considered more or less difficult based on the duration of performing the maneuver, in which case the time-value may be the same across all durations, such as indicated in the example of spins.

Turning back to FIG. 25, in some methods 800, the calculating 808 comprises multiplying 812 the speed-value and the interval-value to calculate the score. Similarly, in some recreational activity systems 350, the controller of the recreational apparatus 352, the mobile device 356, or the server 360 is programmed to multiply the speed-value and the interval-value to calculate the score. For example, with reference to FIGS. 26 and 27 in the example of a drifting vehicle 10, performing a drift of at least 75° but less than 90° at a speed of at least 10 mph but less than 15 mph for a duration of at least five seconds but less than six seconds, results in a speed-value of 7 and a time-value of 5, and thus a score of 35.

In some methods 800, the communicating 810 comprises displaying 814 the score. Similarly, in some recreational activity systems 350, the controller of the recreational apparatus 352, the mobile device 356, or the server 360 is programmed to communicate the score for display on a display device. In particular, the displaying 814 may comprise displaying the score on the mobile device 356, and the controller may be programmed to communicate the score for display on a display device of a mobile device 356.

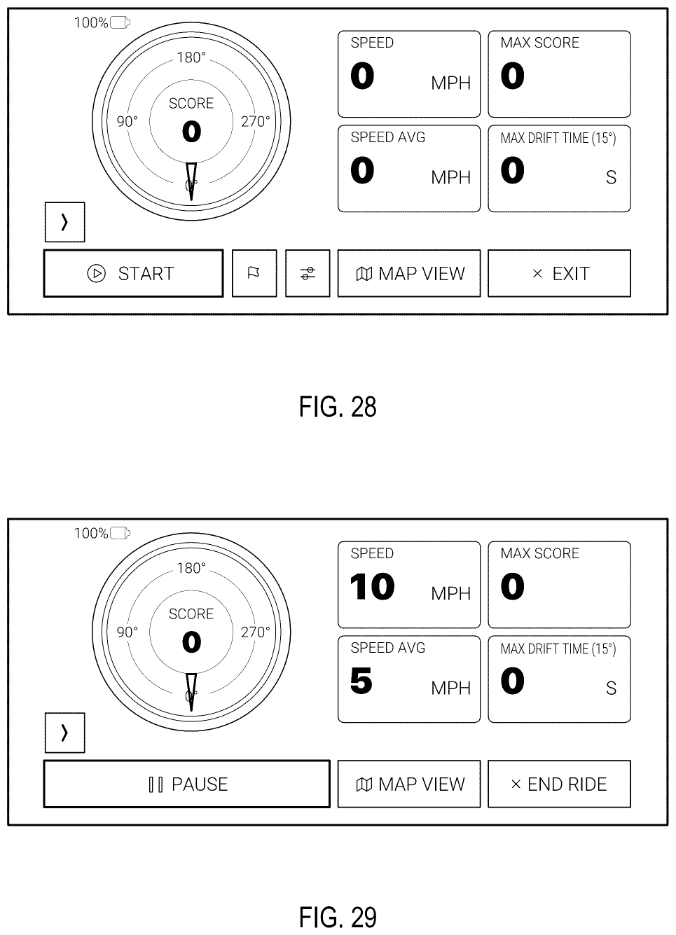

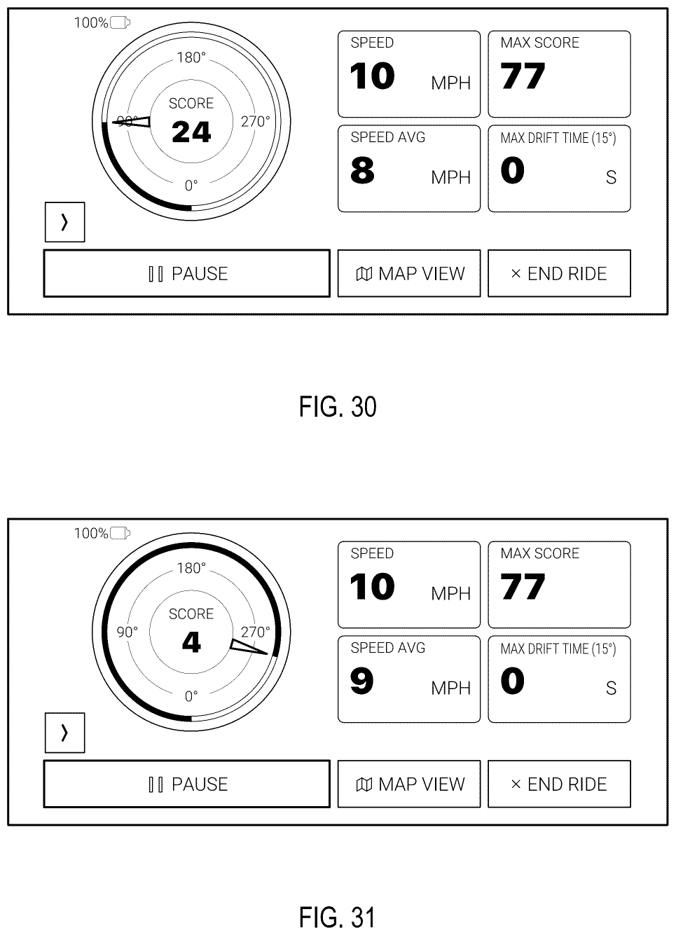

FIGS. 28-31 illustrate examples of display screens of a mobile device 356 associated with drifting vehicles 10. FIG. 28 represents the display screen prior to initiating a ride. FIG. 29 represents the display screen during a ride while the vehicle is traveling at 10 mph but with no drift angle detected. FIG. 30 represents the display screen during a drift of 90° while traveling at 10 mph. A score of 24 is displayed, which with reference to FIGS. 26 and 27 means that the drift of 90° was held by the rider for at least three seconds. If the rider continues to maintain the drift for four seconds, the score will increase to 32. FIG. 31 represents the display screen during a spin maneuver greater than 180° at a speed of 10 mph, and resulting in a score of 4.

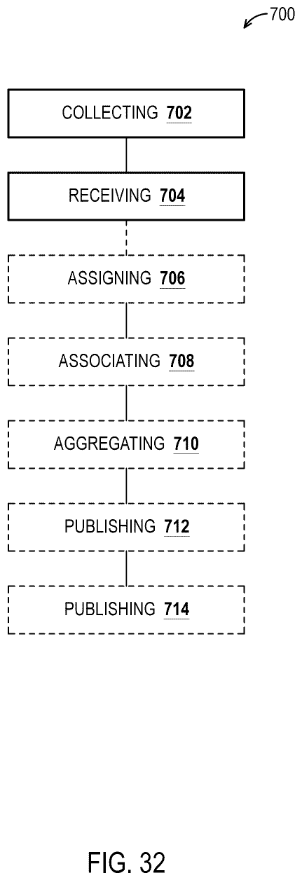

Turning now to FIG. 32, methods 700 may be described as methods associated with recording, rating, and/or otherwise associating routes taken by users of recreational apparatuses 352. For example, as schematically represented in FIG. 32, methods 700 may comprise collecting 702 geographic data that is associated with an instance of use of a recreational apparatus 352 of a plurality of recreational apparatuses 352. For example, the geographic data may comprise one or more of location, change in location, elevation, change in elevation, or other data collected by a GNSS sensor on the recreational apparatus 352 and/or on a mobile device 356 associated with a user of the recreational apparatus 352.

Methods 700 also may comprise receiving 704 user input associated with the instance of use of the recreational apparatus 352. For example, the user input may comprise one or more of data associated with a ride quality, a surface quality, a length of ride, an enjoyment of ride, a number and/or quality of turns, a difficulty, an availability of specific maneuvers, a quality of specific maneuvers, or any other data that the user provides that is associated with the particular instance of use. Using a drifting vehicle 10 as an example, a user may input a value associated with the surface quality (e.g., smooth, rough, bumpy, etc.) and/or surface type (e.g., concrete, asphalt, cobblestone, dirt, hardpack, gravel, etc.), a value associated with the ability to perform certain maneuvers, such as drifts, spins, powerslides, and the like, a value associated with the steepness of the surface, and so forth.

Some methods 700 further comprise assigning 706 a ride value associated with the instance of use of the recreational apparatus 352 based at least in part on the user input. For example, a scale may be used (e.g., 1-10) for ride values, with different values representing different qualities or difficulties of ride. For example, a ride value may be associated with skill level, such as beginner, intermediate, or expert, or with an enjoyment rating, such as boring, meh, chill, exciting, insane, and the like.

Some such methods 700 further comprise associating 708 the ride value to the geographic data. Accordingly, a database 376 may be maintained on a server 360, for example, where instances of rides at various geographic locations are saved together with the associated ride values. Some such methods 700 further comprise aggregating 710 ride values associated with multiple instances of uses of one or more of the plurality of recreational apparatuses 352 to define an aggregated ride value. For example, the aggregated ride value may be an average of ride values determined and/or calculated by multiple uses of recreational apparatuses 352.

Accordingly, some methods 700 further comprise publishing 712 the aggregated ride value in connection with a geographic location and/or publishing 714 ride values associated with multiple instances of uses of one or more of the plurality of recreational apparatuses 352 at a geographic location. Accordingly, users 354 of recreational apparatuses 352 may view the published information and make informed decisions about where they want to use a recreational apparatus 352 in the future.

Illustrative, non-exclusive examples of inventive subject matter according to the present disclosure are described in the following enumerated paragraphs:
A. A vehicle (10) for riding along a ground surface (12), comprising:

a forward assembly (14) comprising:
a front frame assembly (16);
a steering assembly (18) pivotally supported by the front frame assembly (16); and
a front wheel (20) operably coupled to the steering assembly (18) and positioned to engage the ground surface (12); and

a rearward assembly (22) coupled to and extending rearward from the forward assembly (14), wherein the rearward assembly (22) comprises:
a deck (24) having an upper side (26) for supporting a rider in a standing position, and a lower side (27) opposite the upper side (26); and
a rear wheel assembly (28) operably coupled to the deck (24) and positioned to engage the ground surface (12) when the front wheel (20) engages the ground surface (12).
A1. The vehicle (10) of paragraph A, wherein the rear wheel assembly (28) comprises:

a caster assembly (30) operably coupled to the deck (24) opposite the upper side (26); and

a truck assembly (32) operably coupled to the deck (24) opposite the upper side (26) and rearward of the caster assembly (30).
A2. The vehicle (10) of any of paragraphs A-A2, wherein the rearward assembly (22) is configured to be selectively detached from and reattached to the forward assembly (14).
A2.1. the vehicle (10) of paragraph A2,

wherein the deck (24) has a forward deck region (34) and lateral sides (36), wherein the deck (24) comprises a plurality of protrusions (38) extending from the lateral sides (36) within the forward deck region (34) and a plurality of notches (40) extending into the lateral sides (36) within the forward deck region (34) between adjacent pairs of the plurality of protrusions (38);

wherein the forward assembly (14) comprises a deck-receiving bracket (42) operably supported by the front frame assembly (16) and that defines a volume (44) configured to selectively receive the forward deck region (34), wherein the deck-receiving bracket (42) comprises lateral sidewalls (46) and a plurality of retaining shelves (48) extending medially from the lateral sidewalls (46); and

wherein the plurality of protrusions (38) are sized to selectively pass between the plurality of retaining shelves (48) for receipt of the forward deck region (34) into the volume (44) and to selectively translate within the volume (44) for engagement by the plurality of retaining shelves (48) to operably retain the forward deck region (34) within the volume (44).
A2.1.1. The vehicle (10) of paragraph A2.1, wherein the deck (24) comprises:

a main body (50); and

a cap (52) operably coupled to the main body (50) within the forward deck region (34), wherein the cap (52) defines the plurality of protrusions (38) and the plurality of notches (40).
A2.1.1.1. The vehicle (10) of paragraph A2.1.1, wherein the main body (50) and the cap (52) are constructed of different materials.
A2.1.1.2. The vehicle (10) of any of paragraphs A2.1.1-A2.1.1.1, wherein the cap (52) is constructed of a more rigid material than the main body (50).
A2.1.1.3. The vehicle (10) of any of paragraphs A2.1.1-A2.1.1.2,

wherein the deck (24) further comprises a post (54) extending from the upper side (26) of the deck (24) within the forward deck region (34); and

wherein the post (54) is configured to be selectively engaged by the forward assembly (14) when the forward deck region (34) is operatively received in the volume (44) and the plurality of retaining shelves (48) are operably engaged with the plurality of protrusions (38) to operably maintain the forward deck region (34) in the volume (44).
A2.2. The vehicle (10) of any of paragraphs A2-A2.1.1.3, wherein the forward assembly (14) and the rearward assembly (22) collectively define a quick-disconnect assembly (56) configured to selectively release and secure the rearward assembly (22) from and to the forward assembly (14).
A2.2.1. The vehicle (10) of paragraph A2.2, wherein the forward assembly (14) comprises a lever (58) positioned and configured to be engaged by a user, wherein the lever (58) has an open position (60), in which the quick-disconnect assembly (56) permits the forward deck region (34) to be operably received and removed from the volume (44), and a closed position (62), in which the quick-disconnect assembly (56) restricts the forward deck region (34) from being removed from the volume (44) when the forward deck region (34) is operably received in the volume (44).
A2.2.1.1. The vehicle (10) of paragraph A2.2.1, wherein the lever (58) is configured to be selectively locked in the closed position (62) to restrict transition to the open position (60).
A2.2.1.2. The vehicle (10) of any of paragraphs A2.2.1-A2.2.1.1 when depending from paragraph A2.1.1.3, wherein the forward assembly (14) further comprises a post block (64) operably coupled to the lever (58), wherein the post block (64) defines an aperture (66) configured to receive and engage with the post (54) when the forward deck region (34) is received in the volume (44), and wherein the post block (64) is configured to translate the post (54) when the lever (58) transitions between the open position (60) and the closed position (62).
A3. The vehicle (10) of any of paragraphs A-A2.2.1.2,

wherein the front frame assembly (16) comprises a head tube (68);

wherein the steering assembly (18) comprises a steering tube (70) rotatably extending through the head tube (68) and operably coupled to the front wheel (20); and

wherein the forward assembly (14) comprises a limiter (72) configured to selectively limit rotation of the steering tube (70) relative to the head tube (68).
A3.1. The vehicle (10) of paragraph A3, wherein the limiter (72) has a first configuration (74), in which the steering tube (70) is limited to an angular range of rotation relative to the head tube (68), and a second configuration (76), in which the steering tube (70) is limited to no rotation relative to the head tube (68).
A3.1.1. The vehicle (10) of paragraph A3.1, wherein the limiter (72) comprises:

a limiter block (78) fixed to the head tube (68);

a limiter pin (80) extending through the limiter block (78) and configured to be selectively translating between a locked positioned (82) and an unlocked position (84), wherein the limiter pin (80) is spring-biased toward the locked position (82); and

a circumferential flange (85) extending around and fixed relative to the steering tube (70), wherein the circumferential flange (85) defines an arcuate channel (86) and a locking hole (88), wherein each of the arcuate channel (86) and the locking hole (88) are configured to be selectively aligned with the limiter pin (80) for receipt of the limiter pin (80) in the locked position (82), and wherein the limiter (72) is in the first configuration (74) when the limiter pin (80) is received in the arcuate channel (86) and is in the second configuration (76) when the limiter pin (80) is received in the locking hole (88).
A4. The vehicle (10) of any of paragraphs A-A3.1.1,

wherein the front wheel (20) has a front-wheel axis (90) and a front-wheel ground-contacting surface (92);

wherein the rear wheel assembly (28) comprises:
a/the caster assembly (30) operably coupled to the deck (24) opposite the upper side (26), wherein the caster assembly (30) comprises a caster wheel (94) having a caster-wheel axis (96) and a caster-wheel ground-contacting surface (98); and
a/the truck assembly (32) operably coupled to the deck (24) opposite the upper side (26) and rearward of the caster assembly (30), wherein the truck assembly (32) comprises a pair of truck wheels (100), wherein each truck wheel (100) has a truck-wheel axis (102) and a truck-wheel ground-contacting surface (104), and wherein each truck wheel (100) has a truck-wheel center plane (112) that bisects the truck-wheel ground-contacting surface (104); and

wherein when (i) the front-wheel axis (90) and the caster-wheel axis (96) are parallel to a planar ground surface (106), (ii) the front-wheel ground-contacting surface (92) and the caster-wheel ground-contacting surface (98) are engaged with the planar ground surface (106), and (iii) the truck assembly (32) is in a neutral configuration:
the truck-wheel ground-contacting surface (104) and/or the truck-wheel axis (102) of each truck wheel (100) is at a truck-wheel angle (108) relative to the planar ground surface (106);
the vehicle (10) has a vehicle center plane (110) that bisects the vehicle (10) and that is perpendicular to the planar ground surface (106);
a closest distance from an intersection (114) of the truck-wheel center plane (112) and the truck-wheel ground-contacting surface (104) closest to the planar ground surface (106) to the vehicle center plane (110) is a truck-wheel track (116);
a closest distance from the intersection (114) to the planar ground surface (106) is a truck-wheel height (118); and
a closest distance from the lower side (27) of the deck (24) to the planar ground surface (106) is a deck height (119).
A4.1. The vehicle (10) of paragraph A4, wherein the truck-wheel ground-contacting surface (104) is cylindrical.
A4.2. The vehicle (10) of any of paragraphs A4-A4.1, wherein the truck-wheel angle (108) is non-zero.
A4.3. The vehicle (10) of any of paragraphs A4-A4.2, wherein the truck-wheel angle (108) is 1-5 degrees (°), 1-3°, 1-2°, or about 1.2°.
A4.4. The vehicle (10) of any of paragraphs A4-A4.3, wherein the truck-wheel track (116) is 150-500 millimeters (mm), 150-400 mm, 150-300 mm, 150-250 mm, 200-500 mm, 200-400 mm, 200-300 mm, 200-250 mm, or about 236 mm.
A4.5. The vehicle (10) of any of paragraphs A4-A4.4, wherein the truck-wheel height (118) is 5-80 mm, 5-60 mm, 5-40 mm, 5-30 mm, 5-20 mm, 5-10 mm, 10-50 mm, 10-40 mm, 10-30 mm, 10-20 mm, 10-15 mm, or about 22 mm.
A4.6. The vehicle (10) of any of paragraphs A4-A4.5, wherein a ratio of the truck-wheel track (116) to the truck-wheel height (118) is 15-30, 15-25, 15-20, 20-30, 20-25, or about 22.
A4.7. The vehicle (10) of any of paragraphs A4-A4.6, wherein the deck height (119) is 70-200 mm, 70-150 mm, 70-120 mm, 90-200 mm, 90-150 mm, 90-120 mm, or about 111 mm.
A4.8. The vehicle (10) of any of paragraphs A4-A4.8, wherein a ratio of the truck-wheel track (116) to the deck height (119) is 0.5-5, 0.5-4, 0.5-3, 1-5, 1-4, 1-3, 2-5, 2-4, 2-3, or about 2.1.
A4.9. The vehicle (10) of any of paragraphs A4-A4.8, wherein a ratio of the deck height (119) to the truck-wheel height (118) is 5-20, 5-15, 5-12, 10-20, 10-15, 10-12, or about 10.4.
A5. The vehicle (10) of any of paragraphs A-A4.9,

wherein the rear wheel assembly (28) comprises a/the truck assembly (32) operably coupled to the deck (24) opposite the upper side (26); and

wherein the truck assembly (32) comprises truck wheels (100); and

wherein each truck wheel (100) comprises:
a body (120) that defines an axle bore (122); and
a pair of roller bearings (124) operatively received within the axle bore (122);

wherein the pair of roller bearings (124) are spaced apart by a bearing spacing (126); and

wherein each truck wheel (100) has a truck-wheel diameter (128) and a truck-wheel width (130).
A5.1. The vehicle (10) of paragraph A5, wherein the bearing spacing (126) is at least 12 mm.
A5.2. The vehicle (10) of paragraph A5, wherein the bearing spacing (126) is 11-25 mm, 12-25 mm, 13-25 mm, 14-25 mm, 11-20 mm, 12-20 mm, 13-20 mm, 14-20 mm, about 14 mm, about 15 mm, or about 16 mm.
A5.3. The vehicle (10) of any of paragraphs A5-A5.2, wherein a ratio of the truck-wheel diameter (128) to the bearing spacing (126) is 4-10, 5-10, 6-10, 4-9, 4-8, 4-7, 5-7, or about 6.
A5.4. The vehicle (10) of any of paragraphs A5-A5.3, wherein a ratio of the truck-wheel width (130) to the bearing spacing (126) is 1-5, 2-5, 3-5, 3-4, or about 3⅓.
A5.5. The vehicle (10) of any of paragraphs A5-A5.4, wherein a ratio of the truck-wheel diameter (128) to the truck-wheel width (130) is 1-2.5, 1.2-2.5, 1.4-2.5, 1-2, 1.2-2, 1.4-2, 1.6-2, or about 1.8.
A5.6. The vehicle (10) of any of paragraphs A5-A5.5,

wherein the body (120) has a lateral sidewall (132) and a recess (134) extending from the lateral sidewall (132) toward the axle bore (122); and

wherein the lateral sidewall (132) has a sidewall depth (136) from a/the truck-wheel ground-contacting surface (104) to the recess (134).
A5.6.1. The vehicle (10) of paragraph A5.6, wherein the recess (134) is frustoconical.
A5.6.2. The vehicle (10) of any of paragraphs A5.6-A5.6.1, wherein the sidewall depth (136) is 5 -15 mm, 7-15 mm, 5-12 mm, 7-12 mm, 7-10 mm, about 10 mm, or about 9 mm.
A5.6.3. The vehicle (10) of any of paragraphs A5.6-A5.6.2, wherein a ratio of the truck-wheel diameter (128) to the sidewall depth (136) is 5-15, 7-15, 9-15, 5-12, 7-12, 9-12, or about 10.
A5.6.4. The vehicle (10) of any of paragraphs A5.6-A5.6.3, wherein a ratio of the truck-wheel width (130) to the sidewall depth (136) is 3-9, 3-7, 5-7, 5-6, or about 5.5.
A5.6.5. The vehicle (10) of any of paragraphs A5.6-A5.6.4, wherein a transition between the truck-wheel ground-contacting surface (104) to the lateral sidewall (132) has a radius of curvature (138) of 2-10 mm, 2-8 mm, 2-6 mm, 4-10 mm, 4-8 mm, 4-6 mm, or about 5 mm.
A5.6.6. The vehicle (10) of any of paragraphs A5.6-A5.6.5,

wherein the body (120) has a medial sidewall (140) opposite the lateral sidewall (132); and

wherein a transition between the truck-wheel ground-contacting surface (104) to the medial sidewall (140) has a radius of curvature (142) of 2-10 mm, 2-8 mm, 2-6 mm, 4-10 mm, 4-8 mm, 4-6 mm, or about 5 mm.
A5.7. The vehicle (10) of any of paragraphs A5-A5.6.6, wherein the body (120) comprises:

a core (144) that defines the axle bore (122); and

a tire (146) operatively coupled to the core (144) and that defines a/the truck-wheel ground-contacting surface (104).
A5.7.1. The vehicle (10) of paragraph A5.7, wherein the core (144) and the tire (146) are constructed of different materials.
A6. The vehicle (10) of any of paragraphs A-A5.7.1, wherein the forward assembly (14) further comprises a pair of opposing frame sliders (150) operably supported by and extending laterally from the front frame assembly (16).
A6.1. The vehicle (10) of paragraph A6, wherein each frame slider (150) comprises one or more of:

a forward-facing light (152); and/or

a rearward-facing light (154); and/or

a lateral-facing light (156).
A6.2. The vehicle (10) of any of paragraphs A6-A6.1, wherein each frame slider (150) is generally cylindrical.
A6.3. The vehicle (10) of any of paragraphs A6-A6.2, wherein each frame slider (150) is 30-100 mm long.
A6.4. The vehicle (10) of any of paragraphs A6-A6.3, wherein each frame slider (150) is positioned within 100 mm, 200 mm, or 300 mm of the deck (24) and/or within 100 mm, 200 mm, 300 mm, or 400 mm of the ground surface (12).
A7. The vehicle (10) of any of paragraphs A-A6.4, wherein the front wheel (20) is powered.
A7.1. The vehicle (10) of paragraph A7, wherein forward assembly (14) further comprises a hub motor (158) operably coupled to the steering assembly (18), and wherein the front wheel (20) if operably coupled to the hub motor (158).
A8. The vehicle (10) of any of paragraphs A-A7.1, wherein the forward assembly (14) comprises one or more drift sensors (160) configured to measure a drift position of the vehicle (10).
B. A deck (24) for a vehicle (10), the deck (24) comprising:

a forward deck region (34);

lateral sides (36);

a plurality of protrusions (38) extending from the lateral sides (36) within the forward deck region (34); and

a plurality of notches (40) extending into the lateral sides (36) within the forward deck region (34) between adjacent pairs of the plurality of protrusions (38).
B1. The deck (24) of paragraph B, further comprising:

a main body (50); and

a cap (52) operably coupled to the main body (50) within the forward deck region (34), wherein the cap (52) defines the plurality of protrusions (38) and the plurality of notches (40).
B1.1. The deck (24) of paragraph B1, wherein the main body (50) and the cap (52) are constructed of different materials.
B1.2. The deck (24) of any of paragraphs B1-B1.1, wherein the cap (52) is constructed of a more rigid material than the main body (50).
B2. The deck (24) of any of paragraphs B-B1.4, further comprising a post (54) extending from an upper side (26) of the deck (24) within the forward deck region (34).
B3. A rearward assembly (22), comprising:

the deck (24) of any of paragraphs B-B2; and

a rear wheel assembly (28) operably coupled to the deck (24).
B3.1. The rearward assembly (22) of paragraph B3, wherein the rear wheel assembly (28) comprises:

a caster assembly (30) operably coupled to the deck (24); and

a truck assembly (32) operably coupled to the deck (24) rearward of the caster assembly (30).
C. A truck wheel (100) for a truck assembly (32) of a vehicle (10), the truck wheel (100) comprising:

a body (120) that defines an axle bore (122) that defines opposing shelves (148) for operative engagement of a pair of roller bearings (124) within the axle bore (122);

wherein the opposing shelves (148) are spaced apart by a bearing spacing (126); and

wherein each truck wheel (100) has a truck-wheel diameter (128) and a truck-wheel width (130).
C1. The truck wheel (100) of paragraph C, wherein the bearing spacing (126) is at least 12 mm.
C2. The truck wheel (100) of paragraph C, wherein the bearing spacing (126) is 11-25 mm, 12-25 mm, 13-25 mm, 14-25 mm, 11-20 mm, 12-20 mm, 13-20 mm, 14-20 mm, about 14 mm, about 15 mm, or about 16 mm.
C3. The truck wheel (100) of any of paragraphs C-C2, wherein a ratio of the truck-wheel diameter (128) to the bearing spacing (126) is 4-10, 5-10, 6-10, 4-9, 4-8, 4-7, 5-7, or about 6.
C4. The truck wheel (100) of any of paragraphs C-C3, wherein a ratio of the truck-wheel width (130) to the bearing spacing (126) is 1-5, 2-5, 3-5, 3-4, or about 3⅓.
C5. The truck wheel (100) of any of paragraphs C-C4, wherein a ratio of the truck-wheel diameter (128) to the truck-wheel width (130) is 1-2.5, 1.2-2.5, 1.4-2.5, 1-2, 1.2-2, 1.4-2, 1.6-2, or about 1.8.
C6. The truck wheel (100) of any of paragraphs C-C5,

wherein the body (120) has a lateral sidewall (132) and a recess (134) extending from the lateral sidewall (132) toward the axle bore (122);

wherein the truck wheel (100) has a truck-wheel ground-contacting surface (104); and

wherein the lateral sidewall (132) has a sidewall depth (136) from the truck-wheel ground-contacting surface (104) to the recess (134).
C6.1. The truck wheel (100) of paragraph C6, wherein the recess (134) is frustoconical.
C6.2. The truck wheel (100) of any of paragraphs C6-C6.1, wherein the sidewall depth (136) is 5 -15 mm, 7-15 mm, 5-12 mm, 7-12 mm, 7-10 mm, about 10 mm, or about 9 mm.
C6.3. The truck wheel (100) of any of paragraphs C6-C6.2, wherein a ratio of the truck-wheel diameter (128) to the sidewall depth (136) is 5-15, 7-15, 9-15, 5-12, 7-12, 9-12, or about 10.
C6.4. The truck wheel (100) of any of paragraphs C6-C6.3, wherein a ratio of the truck-wheel width (130) to the sidewall depth (136) is 3-9, 3-7, 5-7, 5-6, or about 5.5.
C6.5. The truck wheel (100) of any of paragraphs C6-C6.4, wherein a transition between the truck-wheel ground-contacting surface (104) to the lateral sidewall (132) has a radius of curvature (138) of 2-10 mm, 2-8 mm, 2-6 mm, 4-10 mm, 4-8 mm, 4-6 mm, or about 5 mm.
C6.6. The truck wheel (100) of any of paragraphs C6-C6.5,

wherein the body (120) has a medial sidewall (140) opposite the lateral sidewall (132); and

wherein a transition between the truck-wheel ground-contacting surface (104) to the medial sidewall (140) has a radius of curvature (142) of 2-10 mm, 2-8 mm, 2-6 mm, 4-10 mm, 4-8 mm, 4-6 mm, or about 5 mm.
C7. The truck wheel (100) of any of paragraphs C-C6.6, wherein the body (120) comprises:

a core (144) that defines the axle bore (122); and

a tire (146) operatively coupled to the core (144) and that defines a/the truck-wheel ground-contacting surface (104).
C7.1. The truck wheel (100) of paragraph C7, wherein the core (144) and the tire (146) are constructed of different materials.
D. A method (250) of riding the vehicle (10) of any of paragraphs A1-A8 (when depending from paragraph A1) along the ground surface (12), wherein the caster assembly (30) comprises a/the caster wheel (94), the method (250) comprising:

standing or sitting (254) on the upper side (26) of the deck (24).
D1. The method (250) of paragraph D, further comprising initiating (256) a drift in a drift direction, wherein the initiating (256) comprises urging (258) the deck (24) to pivot relative to the steering assembly (18) in the drift direction.
D1.1. The method (250) of paragraph D1, wherein the urging (258) results in the caster wheel (94) pivoting to face the drift direction.
D1.2. The method (250) of any of paragraphs D1-D1.1, wherein the urging (258) results in a first truck wheel (100) of the truck assembly (32) opposite the drift direction contacting and skidding on the ground surface (12) and a second truck wheel (100) of the truck assembly (32) opposite the first truck wheel (100) not contacting the ground surface (12).
D1.3. The method (250) of any of paragraphs D1-D1.2, wherein the initiating (256) further comprises tilting (260) the deck (24) opposite the drift direction.
D1.3.1. The method (250) of paragraph D1.3, wherein the tilting (260) comprises tilting the rider's foot or feet opposite the drift direction.
D1.4. The method (250) of any of paragraphs D1-D1.3.1, wherein the urging (158) comprises shifting (262) the rider's center of gravity in the drift direction.
D1.4.1. The method (250) of paragraph D1.4, wherein the shifting (262) comprises moving (264) the rider's hips in the drift direction.
D1.5. The method (250) of any of paragraphs D1-D1.4.1, further comprising maintaining (266) the drift in the drift direction, wherein the maintaining (266) comprises ceasing (268) the urging.
D1.5.1. The method (250) of paragraph D1.5 when depending from paragraph D1.4.1, wherein the ceasing (268) comprises moving (270) the rider's shoulders opposite the drift direction.
D1.5.2. The method (250) of any of paragraphs D1.5-D1.5.1 when depending from paragraph D1.3, wherein the maintaining (266) the drift in the drift direction comprises continuing (272) to tilt the deck (24) opposite the drift direction.
D1.5.3. The method (250) of any of paragraphs D1.5-D1.5.2, wherein the maintaining (266) further comprises steering (274) the front wheel (20) in the drift direction.
D1.5.4. The method (250) of any of paragraphs D1.5-D1.5.3, wherein the maintaining (266) further comprises increasing (276) rotation of the front wheel (20).
D1.5.4.1. The method (250) of paragraph D1.5.4,

wherein the forward assembly (14) of the vehicle further comprises a/the motor (158) operatively coupled to the front wheel (20); and

wherein the increasing (276) rotation comprises increasing (278) power to the motor (158).
D1.5.4.2. The method (250) of any of paragraphs D1.5.4-D1.5.4.1, wherein the increasing (276) rotation comprises riding (281) the vehicle (10) down a steeper incline.
D1.6. The method (250) of any of paragraphs D1-D1.5.3.4.2, further comprising increasing (280) the drift in the drift direction.
D1.6.1. The method (250) of paragraph D1.6, wherein the increasing (280) comprises continuing (282) to urge the deck (24) in the drift direction.
D1.6.2. The method (250) of any of paragraphs D1.6-D1.6.1, wherein the increasing (280) comprises steering (284) the front wheel (20) opposite the drift direction.
D1.6.3. The method (250) of any of paragraphs D1.6-D1.6.2, wherein the increasing (280) comprises increasing (286) rotation of the front wheel (20).
D1.6.3.1. The method (250) of paragraph D1.6.3,

wherein the forward assembly (14) of the vehicle (10) further comprises a/the motor (158) operatively coupled to the front wheel (20); and

wherein the increasing (286) rotation comprises increasing (288) power to the motor (158).
D1.6.3.2. The method (250) of any of paragraphs D1.6.3-D1.6.3.1, wherein the increasing (286) rotation comprises riding (290) the vehicle (10) down a steeper incline.
D1.6.4. The method (250) of any of paragraphs D1.6-D1.6.3.2, wherein the increasing (280) comprises maintaining (292) the rider's center of gravity in a position relative to the deck (24).
D1.6.5. The method (250) of any of paragraphs D1.6-D1.6.4, wherein the increasing (280) comprises shifting (294) the rider's center of gravity further in the drift direction.
D1.7. The method (250) of any of paragraphs D1-D1.6.5, further comprising reducing (296) the drift.
D1.7.1. The method (250) of paragraph D1.7, wherein the reducing (296) comprises steering (298) the front wheel (20) in the drift direction.
D1.7.2. The method (250) of any of paragraphs D1.7-D1.7.1, wherein the reducing (296) comprises increasing (300) rotation of the front wheel (20).
D1.7.2.1. The method (250) of paragraph D1.7.2,

wherein the forward assembly (14) of the vehicle (10) further comprises a/the motor (158) operatively coupled to the front wheel (20); and

wherein the increasing (300) rotation comprises increasing (302) power to the motor (158).
D1.7.2.2. The method (250) of any of paragraphs D1.7.2-D1.7.2.1, wherein the increasing (300) rotation comprises riding (304) the vehicle (10) down a steeper incline.
D1.7.2.3. The method (250) of any of paragraphs D1.7.2-d1.7.2.2 when depending from paragraph D1.7.1, wherein the steering (298) and the increasing (300) are performed simultaneously.
D1.7.3. The method (250) of any of paragraphs D1.7-D1.7.2.3, wherein the reducing (296) comprises shifting (306) the rider's center of gravity toward the front wheel (20).
D1.7.4. The method (250) of any of paragraphs D1.7-D1.7.3, wherein the reducing (296) comprises shifting (308) the rider's center of gravity away from the drift direction.
E. A method (250) of riding the vehicle (10) of any of paragraphs A1-A8 (when depending from paragraph A1) along the ground surface (12), wherein the caster assembly (30) comprises a/the caster wheel (94), the method (250) comprising:

locking (310) the caster assembly (30) with the caster wheel (94) aligned with the deck (24) to restrict pivoting of the caster wheel (94); and

standing or sitting (312) on the upper side (26) of the deck (24).
E1. The method (250) of paragraph E, further comprising turning (314) the vehicle (10) in a turn direction without drifting.
E1.1. The method (250) of paragraph E1, wherein the turning (314) comprises tilting (318) the deck (24) in the turn direction.
E1.1.1. The method (250) of paragraph E1.1, wherein the tilting (318) results in a/the first truck wheel (100) of the truck assembly (32) on a side of the truck assembly (32) corresponding to the turn direction contacting the ground surface (12) and a/the second truck wheel (100) of the truck assembly (32) opposite the first truck wheel (100) not contacting the ground surface (12).
E1.2. The method (250) of any of paragraphs E1-E1.1.1, wherein the turning (314) comprises steering (320) the front wheel (20) in the turn direction.
E1.2.1. The method (250) of paragraph E1.2 when depending from paragraph E1.1, wherein the steering (320) is initiated simultaneously with or immediately following (e.g., within one second, within half a second, or within a quarter of a second of) initiation of the tilting (318).
E1.3. The method (250) any of paragraphs E1-E1.2.1, wherein the turning (314) comprises shifting (322) the rider's center of gravity in the turn direction.
E1.3.1. The method (250) of paragraph E1.3 when depending from paragraph E1.1, wherein the shifting (322) is initiated simultaneously with or immediately following (e.g., within one second, within half a second, or within a quarter of a second of) the initiating of the tilting (318).
E1.3.2. The method (250) of any of paragraphs E1.3-E1.3.1 when depending from paragraph E1.2, wherein the shifting (322) is initiated simultaneously with or immediately following (e.g., within one second, within half a second, or within a quarter of a second of) initiation of the steering (320).
E1.4. The method (250) of any of paragraphs E1-E1.3.2, wherein the turn direction is a first turn direction, the method (250) further comprising:

following the turning (314) the vehicle (10) in the first turn direction, turning (314) the vehicle (10) in a second turn direction opposite the first turn direction.
E1.4.1. The method (250) of paragraph E1.4, further comprising repeating (326) the turning (314) the vehicle (10) in the first turn direction and the turning (314) the vehicle (10) in the second turn direction.
E2. The method (250) of any of paragraphs E-E1.4.1, further comprising the method (250) of any of paragraphs D-D1.7.4.
F. A recreational apparatus (352), comprising:

a controller (362) configured to control aspects of the recreational apparatus (352) based at least in part on an identification (364) of a particular user (354) of the recreational apparatus (352).
F1. The recreational apparatus (352) of paragraph F, wherein the controller (362) is configured to:

limit one or more performance aspects (366) of the recreational apparatus (352) based at least in part on the identification (364) of the particular user (354); and/or

control activation of one or more features (378) of the recreational apparatus (352) based at least in part on the identification (364) of the particular user (354).
F1.1. The recreational apparatus (352) of paragraph F1, wherein the one or more performance aspects (366) comprises a maximum speed permitted by the recreational apparatus (352).
F1.2. The recreational apparatus (352) of any of paragraphs F1-F1.1, wherein the one or more features (378) comprises one or more physical features, one or more visual features, and/or one or more audible features.
F2. The recreational apparatus (352) of any of paragraphs F-F1.2, wherein the identification (364) of the particular user (354) is based at least in part on historical data (368) associated with the particular user (354).
F2.1. The recreational apparatus (352) of paragraph F2, wherein the historical data (368) comprises data associated with the particular user (354) using any one of a plurality of recreational apparatuses (352).
F2.2. The recreational apparatus (352) of any of paragraphs F2-F2.1, wherein the historical data (368) comprises one or more of:

a cumulative distance the particular user (354) has ridden the recreational apparatus (352) or any one of a/the plurality of recreational apparatuses (352);

a cumulative duration the particular user (354) has used the recreational apparatus (352) or any one of the plurality of recreational apparatuses (352);

identification of one or more maneuvers performed by the particular user (354) on the recreational apparatus (352) or any one of the plurality of recreational apparatuses (352); or

a performance score (370) associated with the particular user (354).
F2.2.1. The recreational apparatus (352) of paragraph F2.2, wherein the performance score (370) is based at least in part on one or more of:

difficulty levels assigned to specific maneuvers;

the cumulative distance the particular user (354) has ridden the recreational apparatus (352) or any one of the plurality of recreational apparatuses (352);

the cumulative duration the particular user (354) has used the recreational apparatus (352) or any one of the plurality of recreational apparatuses (352);

the identification of the one or more maneuvers performed by the particular user (354) on the recreational apparatus (352) or any one of the plurality of recreational apparatuses (352); or

a cumulative quantity of particular maneuvers performed by the particular user (354) on the recreational apparatus (352) or any one of the plurality of recreational apparatuses (352).
F2.2.2. The recreational apparatus (352) of any of paragraphs F2.2-F2.2.1, wherein the one or more maneuvers comprise one or more of drifts, spins, drift angles, carving, jumps, or reverses.
F3. The recreational apparatus (352) of any of paragraphs F-F2.2.2, further comprising one or more sensors (372) configured to detect one or more conditions (374) associated with the recreational apparatus (352), wherein the controller (362) is configured to communicate the conditions (374) for association with the identification (364) of particular user (354).
F3.1. The recreational apparatus (352) of paragraph F3, wherein the one or more conditions comprise:

an angular velocity of a component of the recreational apparatus (352);

an angular displacement of the component of the recreational apparatus (352);

a speed of the recreational apparatus (352);

a speed of the component of the recreational apparatus (352);

an acceleration of the recreational apparatus (352);

an acceleration of the component of the recreational apparatus (352);

a rotational speed of one or more wheels of the recreational apparatus (352); or

a location of the recreational apparatus (352).
F3.2. The recreational apparatus (352) of any of paragraphs F3-F3.1, wherein the one or more sensors (372) comprise one or more of: a speedometer, a light-based sensor, a camera, a GNSS sensor, an inertial measurement unit, an accelerometer, a radar sensor, a lidar sensor, or a potentiometer.
F4. The recreational apparatus (352) of any of paragraphs F-F3.2, wherein the controller (362) is configured to perform the method of any of paragraphs G-G3.
F5. The recreational apparatus (352) of any of paragraphs F-F4, wherein the recreational apparatus (352) is the vehicle (10) of any of paragraphs A-A8.
G. A method (400), comprising:

controlling (402) aspects of a recreational apparatus (352) based at least in part on an identification (364) of a particular user (354) of the recreational apparatus (352).
G1. The method (400) of paragraph G, wherein the controlling (402) comprises:

limiting (404) one or more performance aspects (366) of the recreational apparatus (352); and/or

activating (412) one or more features (378) of the recreational apparatus (352).
G1.1. The method (400) of paragraph G, wherein the limiting (404) and/or the activating (412) are based at least in part on historical data (368) associated with the particular user (354).
G1.1.1. The method (400) of paragraph G1.1, wherein the historical data (368) comprises data associated with the particular user (354) using any one of a plurality of recreational apparatuses (352).
G1.1.2. The method (400) of any of paragraphs G1.1-G1.1.1, wherein the historical data (368) comprises one or more of:

a cumulative distance the particular user (354) has ridden the recreational apparatus (352) or any one of a/the plurality of recreational apparatuses (352);

a cumulative duration the particular user (354) has used the recreational apparatus (352) or any one of the plurality of recreational apparatuses (352);

identification of one or more maneuvers performed by the particular user (354) on the recreational apparatus (352) or any one of the plurality of recreational apparatuses (352); or

a performance score (370) associated with the particular user (354).
G1.1.2.1. The method (400) of paragraph G1.1.2, wherein the performance score (370) is based at least in part on one or more of:

difficulty levels assigned to specific maneuvers;

the cumulative distance the particular user (354) has ridden the recreational apparatus (352) or any one of the plurality of recreational apparatuses (352);

the cumulative duration the particular user (354) has used the recreational apparatus (352) or any one of the plurality of recreational apparatuses (352);

the identification of the one or more maneuvers performed by the particular user (354) on the recreational apparatus (352) or any one of the plurality of recreational apparatuses (352); or

a cumulative quantity of particular maneuvers performed by the particular user (354) on the recreational apparatus (352) or any one of the plurality of recreational apparatuses (352).
G1.1.2.3. The method (400) of any of paragraphs G1.1.2-G1.1.2.2, wherein the one or more maneuvers comprise one or more of drifts, spins, drift angles, carving, jumps, or reverses.
G1.1.3. The method (400) of any of paragraphs G1.1-G1.1.2.3, further comprising receiving (406) from a mobile device (356) data (e.g., a/the performance score (370)) associated with the historical data (368), wherein the limiting (404) is based at least in part on the data received from the mobile device (356).
G2. The method (400) of any of paragraphs G-G1.1.3, further comprising:

sensing (408) one or more conditions (374) associated with the recreational apparatus (352); and

sending (410) to a/the mobile device (356) data associated with the one or more conditions (374) for association with the identification (364) of the particular user (354).
G2.1. The method (400) of paragraph G2, wherein the one or more conditions comprise:

an angular velocity of a component of the recreational apparatus (352);

an angular displacement of the component of the recreational apparatus (352);

a speed of the recreational apparatus (352);

a speed of the component of the recreational apparatus (352);

an acceleration of the recreational apparatus (352);

an acceleration of the component of the recreational apparatus (352); or

a rotational speed of one or more wheels of the recreational apparatus (352).
G3. The method (400) of any of paragraphs G-G2.1, wherein the recreational apparatus (352) is the recreational apparatus (352) of any of paragraphs F-F5.
H. A method (500), comprising:

receiving (502) from a recreational apparatus (352) data associated with one or more conditions (374) sensed by the recreational apparatus (352); and/or

sending (508) to the recreational apparatus (352) data (e.g., a performance score (370)) associated with historical data (368) of a particular user (354) of the recreational apparatus (352) or of a plurality of recreational apparatuses (352); and/or

receiving (510) from a server (360) the data associated with the historical data (368).
H1. The method (500) of paragraph H, further comprising displaying (504) the data associated with the one more conditions (374) sensed by the recreational apparatus (352) and/or the data associated with historical data (368).
H2. The method (500) of any of paragraphs H-H1, further comprising sending (506) to a server (360) the data associated with the one or more conditions (374) sensed by the recreational apparatus (352).
H3. The method (500) of any of paragraphs H-H2, further comprising receiving (510) from a/the server (360) the data associated with the historical data (368).
H4. The method (500) of any of paragraphs H-H3, further comprising alerting (512) the particular user (354) of a notification based at least in part on the historical data (368) of the particular user (354).
H5. The method (500) of any of paragraphs H-H4, wherein the recreational apparatus (352) is the recreational apparatus (352) of any of paragraphs F-F5.
I. A method (600), comprising sending (602) to a mobile device (356) data (e.g., a performance score (370)) associated with historical data (368) of a particular user (354) of a recreational apparatus (352) or of any one of a plurality of recreational apparatuses (352).
I1. The method (600) of paragraph I, further comprising calculating (604) the data associated with the historical data (368) of the particular user (354).
I2. The method (600) of any of paragraphs I-I1, further comprising receiving (606) from the mobile device (356) data associated with one or more conditions (374) sensed by the recreational apparatus (352) or the plurality of recreational apparatuses (352) when operated by the particular user (354), wherein the historical data (368) comprises the data associated with the one or more conditions (374).
I3. The method (600) of any of paragraphs I-I2, further comprising maintaining (608) a database (376) of data associated with historical data (368) of a plurality of users (354) of the plurality of recreational apparatuses (352).
I4. The method (600) of any of paragraphs I-I3, further comprising publishing (610) data associated with historical data (368) of a/the plurality of users (354) of the plurality of recreational apparatuses (352).
I5. The method (600) of any of paragraphs I-I4, further comprising alerting (612) the particular user (354) of a notification based at least in part on the historical data (368) of the particular user (354).
I5.1. The method (600) of paragraph I5, wherein the notification comprises information related to a component of the recreational apparatus (352).
I5.1.1.The method (600) of paragraph I5.1, wherein the notification comprises information indicating that the component of the recreational apparatus (352) needs to be, or may need to be, replaced or serviced.
I6. The method (600) of any of paragraphs I-I5.1.1, further comprising the method of any of paragraphs G-H5.
J. A method (700), comprising:

collecting (702) geographic data associated with an instance of use of a recreational apparatus (352) of a plurality of recreational apparatuses (352); and

receiving (704) user input associated with the instance of use of the recreational apparatus (352).
J1. The method (700) of paragraph J, wherein the geographic data comprises one or more of location, change in location, elevation, or change in elevation.
J2. The method (700) of any of paragraphs J-J1, wherein the user input comprises one or more of data associated with a ride quality, a surface quality, a length of ride, an enjoyment of ride, a number and/or quality of turns, a difficulty, an availability of specific maneuvers, or a quality of specific maneuvers.
J3. The method (700) of any of paragraphs J-J2, further comprising assigning (706) a ride value associated with the instance of use of the recreational apparatus (352) based at least in part on the user input.
J3.1. The method (700) of paragraph J3, further comprising associating (708) the ride value to the geographic data.
J3.2. The method (700) of any of paragraphs J3-J3.1, further comprising aggregating (710) ride values associated with multiple instances of uses of one or more of the plurality of recreational apparatuses (352) to define an aggregated ride value.
J3.2.1.The method (700) of paragraph J3.2, further comprising publishing (712) the aggregated ride value in connection with a geographic location.
J3.3. The method (700) of any of paragraphs J3-J3.2.1, further comprising publishing (714) ride values associated with multiple instances of uses of one or more of the plurality of recreational apparatuses (352).
J4. The method (700) of any of paragraphs J-J3.3, further comprising the method of any of paragraphs G-I6.
K. A recreational activity system (350), comprising:

a server (360) configured to:
communicate with a plurality of recreational apparatuses (352) and receive data from the plurality of recreational apparatuses (352); and

associate the data received by the server (360) from the plurality of recreational apparatuses (352) to individual users (354) of the plurality of recreational apparatuses (352) regardless of which one of the plurality of recreational apparatuses (352) an individual user (354) used.
K1. The recreational activity system (350) of paragraph K, wherein the server (360) is further configured to aggregate the data associated with each individual user (354) across multiple ones of the plurality of recreational apparatuses (352).
K2. The recreational activity system (350) of any of paragraphs K-K1, wherein the server (360) is further configured to send instructions to an individual recreational apparatus (352) of the plurality of recreational apparatuses (352) being used by a particular user (354), wherein the instructions are based at least in part on the data received from the plurality of recreational apparatuses (352) associated with the particular user (354).
K2.1. The recreational activity system (350) of paragraph K2, wherein the instructions are configured to control aspects of the individual recreational apparatus (352).
K2.1.1. The recreational activity system (350) of paragraph K2.1, wherein the instructions are configured to:

limit one or more performance aspects (366) of the individual recreational apparatus (352); and/or

activate one or more performance aspects (366) of the individual recreational apparatus (352).
K3. The recreational activity system (350) of any of paragraphs K-K2.1.1, further comprising the plurality of recreational apparatuses (352).
K4. The recreational activity system (350) of any of paragraphs K-K3, wherein each recreational apparatus (352) is the recreational apparatus (352) of any of paragraphs F-F5.
K5. The recreational activity system (350) of any of paragraphs K-K4, wherein each recreational apparatus (352) is the vehicle (10) of any of paragraphs A-A8.
L. A method (600), comprising:

receiving (614) by a server (360) data from a plurality of recreational apparatuses (352); and

associating (616) by the server (360) the data received from the plurality of recreational apparatuses (352) with individual users (354) of the plurality of recreational apparatuses (352) regardless of which one of the plurality of recreational apparatuses (352) an individual user (354) used.
L1. The method (600) of paragraph L, further comprising aggregating (618) the data associated with each individual user (354) across multiple ones of the plurality of recreational apparatuses (352).
L2. The method (600) of any of paragraphs L-L1, further comprising sending (620) instructions to an individual recreational apparatus (352) of the plurality of recreational apparatuses (352) being used by a particular user (354), wherein the instructions are based at least in part on the data received from the plurality of recreational apparatuses (352) associated with the particular user (354).
L2.1. The method (600) of paragraph L2, wherein the sending (620) comprises sending the instructions to a mobile device (356) associated with the particular user (354) for delivery to the individual recreational apparatus (352).
L2.2. The method (600) of any of paragraphs L2-L2.1, wherein the instructions are configured to control aspects of the individual recreational apparatus (352).
L2.2.1. The method (600) of paragraph L2.2, wherein the instructions are configured to:

limit one or more performance aspects (366) of the individual recreational apparatus (352); and/or

activate one or more performance aspects (366) of the individual recreational apparatus (352).
L3. The method (600) of any of paragraphs L-L2.2.1, wherein each recreational apparatus (352) is the recreational apparatus (352) of any of paragraphs F-F5.
L4. The method (600) of any of paragraphs L-L3, wherein each recreational apparatus (352) is the vehicle (10) of any of paragraphs A-A8.
L5. The method (600) of any of paragraphs L-L4, further comprising the method of any of paragraphs G-J4.
M. A method (800), comprising:

detecting (802) a speed of a recreational apparatus (352);

detecting (804) a specific maneuver of the recreational apparatus (352);

measuring (806) a time interval that the specific maneuver is performed;

calculating (808) a score based on a speed-value associated with the specific maneuver at the speed and an interval-value associated with the time internal; and

communicating (810) the score.
M1. The method (800) of paragraph M, wherein the calculating (808) comprises multiplying (812) the speed-value and the interval-value to calculate the score.
M2. The method (800) of any of paragraphs M-M1, wherein the communicating (810) comprises displaying (814) the score.
M2.1. The method (800) of paragraph M2, wherein the displaying (814) comprises displaying the score on a mobile device (356).
M3. The method (800) of any of paragraphs M-M2.1, wherein the specific maneuver is one of a plurality of maneuvers, wherein each maneuver of the plurality of maneuvers has distinct speed-values associated with it.
M3.1. The method (800) of paragraph M3, wherein the plurality of maneuvers comprises a plurality of drifts, wherein each drift of the plurality of drifts has a distinct angle of drift.
M3.2. The method (800) of any of paragraphs M3-M3.1, wherein the plurality of maneuvers comprises a plurality of spins, wherein each spin of the plurality of spins has a distinct angle of spin.
M4. The method (800) of any of paragraphs M-M3.2, wherein the recreational apparatus (352) comprises the recreational apparatus (352) of any of paragraphs F-F5.
M5. The method (800) of any of paragraphs M-M4, wherein the recreational apparatus (352) comprises the vehicle (10) of any of paragraphs A-A8.
N. A recreational activity system (350), comprising:

sensors (372,386) configured to detect (i) a speed of a recreational apparatus (352), and (ii) a specific maneuver of the recreational apparatus (352);

a timer (380,388) configured to measure a time interval that the specific maneuver is performed by the recreational apparatus (352); and

a controller (362,382,384) of the recreational apparatus (352), a mobile device (356), or a server (360) programmed to:
calculate a score based on a speed-value associated with the specific maneuver at the speed and an interval-value associated with the time interval; and
communicate the score.
N1. The recreational activity system (350) of paragraph N, wherein the controller (362,382,384) of the recreational apparatus (352), the mobile device (356), or the server (360) is programmed to multiply the speed-value and the interval-value to calculate the score.
N2. The recreational activity system (350) of any of paragraphs N-N1, wherein the controller (362,382,384) of the recreational apparatus (352), the mobile device (356), or the server (360) is programmed to communicate the score for display on a display device.
N2.1. The recreational activity system (350) of paragraph N2, wherein the display device is on the mobile device (356).
N3. The recreational activity system (350) of any of paragraphs N-N2.1, wherein the specific maneuver is one of a plurality of maneuvers, wherein each maneuver of the plurality of maneuvers has distinct speed-values associated with it.
N3.1. The recreational activity system (350) of paragraph N3, wherein the plurality of maneuvers comprises a plurality of drifts, wherein each drift of the plurality of drifts has a distinct angle of drift.
N3.2. The recreational activity system (350) of any of paragraphs N3-N3.1, wherein the plurality of maneuvers comprises a plurality of spins, wherein each spin of the plurality of spins has a distinct angle of spin.
N4. The recreational activity system (350) of any of paragraphs N-N3.2, wherein the recreational apparatus (352) comprises the sensors (372).
N5. The recreational activity system (350) of any of paragraphs N-N4, wherein the recreational apparatus (352) comprises the timer (380).
N6. The recreational activity system (350) of any of paragraphs N-N5 excluding paragraph N4, wherein the mobile device (356) comprises the sensors (386).
N7. The recreational activity system (350) of any of paragraphs N-N6 excluding paragraph N5, wherein the mobile device (356) comprises the timer (388).
N8. The recreational activity system (350) of any of paragraphs N-N7, wherein the controller (362) of the recreational apparatus (352) is programmed to calculate the score and communicate the score.
N9. The recreational activity system (350) of any of paragraphs N-N8, wherein the controller (382) of the mobile device (356) is programmed to calculate the score and communicate the score.
N10. The recreational activity system (350) of any of paragraphs N-N9, wherein the controller (384) of the server (360) is programmed to calculate the score and communicate the score.
N11. The recreational activity system (350) of any of paragraphs N-N10, wherein the recreational apparatus (352) comprises the recreational apparatus (352) of any of paragraphs F-F5.
N12. The recreational activity system (350) of any of paragraphs N-N11, wherein the recreational apparatus (352) comprises the vehicle (10) of any of paragraphs A-A8.
N13. The recreational activity system (350) of any of paragraphs N-N12, wherein the recreational activity system (350) comprises the recreational activity system (350) of any of paragraphs K-K5.
O. Non-transitory computer-readable storage media comprising computer executable software that when executed direct a computing device to perform the method of any of paragraphs G-J4 or L-M5.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. A recreational apparatus (352), comprising:
a controller (362) configured to control aspects of the recreational apparatus (352) based at least in part on an identification (364) of a particular user (354) of the recreational apparatus (352) wherein the controller (362) is configured to:
limit one or more performance aspects (366) of the recreational apparatus (352) based at least in part on the identification (364) of the particular user (354); and/or
activate one or more features (378) of the recreational apparatus (352) based at least in part on the identification (364) of the particular user (354).

2. The recreational apparatus (352) of claim 1,
wherein the controller (362) is configured to limit one or more performance aspects (366) of the recreational apparatus (352) based at least in part on the identification (364) of the particular user (354); and
wherein the one or more performance aspects (366) comprises maximum speed permitted by the recreational apparatus (352).

3. The recreational apparatus (352) of claim 1,
wherein the controller (362) is configured to activate one or more features (378) of the recreational apparatus (352) based at least in part on the identification (364) of the particular user (354); and
wherein the one or more features (378) comprises one or more physical features, one or more visual features, and/or one or more audible features.

4. The recreational apparatus (352) of claim 1, wherein the identification (364) of the particular user (354) is based at least in part on historical data (368) associated with the particular user (354).

5. The recreational apparatus (352) of claim 4, wherein the historical data (368) comprises data associated with the particular user (354) using any one of a plurality of recreational apparatuses (352).

6. The recreational apparatus (352) of claim 4, wherein the historical data (318) comprises one or more of:
a cumulative distance the particular user (354) has ridden the recreational apparatus (352) or any one of a plurality of recreational apparatuses (352);
a cumulative duration the particular user (354) has used the recreational apparatus (352) or any one of the plurality of recreational apparatuses (352);
identification of one or more maneuvers performed by the particular user (354) on the recreational apparatus (352) or any one of the plurality of recreational apparatuses (352); or
a performance score (370) associated with the particular user (354).

7. The recreational apparatus (352) of claim 6, wherein the historical data (318) comprises the performance score (370), and wherein the performance score (370) is based at least in part on one or more of:
difficulty levels assigned to specific maneuvers;
the cumulative distance the particular user (354) has ridden the recreational apparatus (352) or any one of the plurality of recreational apparatuses (352);
the cumulative duration the particular user (354) has used the recreational apparatus (352) or any one of the plurality of recreational apparatuses (352);
the identification of the one or more maneuvers performed by the particular user (354) on the recreational apparatus (352) or any one of the plurality of recreational apparatuses (352); or
a cumulative quantity of particular maneuvers performed by the particular user (354) on the recreational apparatus (352) or any one of the plurality of recreational apparatuses (352).

8. The recreational apparatus (352) of claim 1, further comprising one or more sensors (372) configured to detect one or more conditions (374) associated with the recreational apparatus (352), wherein the controller (362) is configured to communicate the conditions (374) for association with the identification (364) of particular user (354).

9. The recreational apparatus (352) of claim 8, wherein the one or more conditions comprise:
an angular velocity of a component of the recreational apparatus (352);
an angular displacement of the component of the recreational apparatus (352);
a speed of the recreational apparatus (352);
a speed of the component of the recreational apparatus (352);
an acceleration of the recreational apparatus (352);
an acceleration of the component of the recreational apparatus (352);
a rotational speed of one or more wheels of the recreational apparatus (352); or
a location of the recreational apparatus (352).

10. The recreational apparatus (352) of claim 8, wherein the one or more sensors (372) comprise one or more of: a speedometer, a light-based sensor, a camera, a GNSS sensor, an inertial measurement unit, an accelerometer, a radar sensor, a lidar sensor, or a potentiometer.

11. A method (400), comprising:
controlling (402) aspects of a recreational apparatus (352) based at least in part on an identification (364) of a particular user (354) of the recreational apparatus (352), wherein the controlling (402) comprises:
limiting (404) one or more performance aspects (366) of the recreational apparatus (352); and/or
activating (412) one or more features (378) of the recreational apparatus (352).

12. The method (400) of claim 11, wherein the limiting (404) and/or the activating (412) are based at least in part on historical data (368) associated with the particular user (354).

13. The method (400) of claim 12, wherein the historical data (368) comprises data associated with the particular user (354) using any one of a plurality of recreational apparatuses (352).

14. The method (400) of claim 13, wherein the historical data (368) comprises one or more of:
a cumulative distance the particular user (354) has ridden the recreational apparatus (352) or any one of a/the plurality of recreational apparatuses (352);
a cumulative duration the particular user (354) has used the recreational apparatus (352) or any one of the plurality of recreational apparatuses (352);
identification of one or more maneuvers performed by the particular user (354) on the recreational apparatus (352) or any one of the plurality of recreational apparatuses (352); or
a performance score (370) associated with the particular user (354).

15. The method (400) of claim 14, wherein the historical data (368) comprises the performance score, and wherein the performance score (370) is based at least in part on one or more of:
difficulty levels assigned to specific maneuvers;
the cumulative distance the particular user (354) has ridden the recreational apparatus (352) or any one of the plurality of recreational apparatuses (352);
the cumulative duration the particular user (354) has used the recreational apparatus (352) or any one of the plurality of recreational apparatuses (352);
the identification of maneuvers performed by the particular user (354) on the recreational apparatus (352) or any one of the plurality of recreational apparatuses (352); or
a cumulative quantity of particular maneuvers performed by the particular user (354) on the recreational apparatus (352) or any one of the plurality of recreational apparatuses (352).

16. The method (400) of claim 12, further comprising receiving (406) from a mobile device (356) data associated with the historical data (368), wherein the limiting (404) is based at least in part on the data received from the mobile device (356).

17. The method (400) of claim 11, further comprising:
sensing (408) one or more conditions (374) associated with the recreational apparatus (352); and
sending (410) to a mobile device (356) data associated with the one or more conditions (374) for association with the identification (364) of the particular user (354).

18. The method (400) of claim 17, wherein the one or more conditions comprise:
an angular velocity of a component of the recreational apparatus (352);
an angular displacement of the component of the recreational apparatus (352);
a speed of the recreational apparatus (352);
a speed of the component of the recreational apparatus (352);
an acceleration of the recreational apparatus (352);
an acceleration of the component of the recreational apparatus (352); or
a rotational speed of one or more wheels of the recreational apparatus (352).

19. A method (500), comprising:
receiving (502) from a recreational apparatus (352) data associated with one or more conditions (374) sensed by the recreational apparatus (352);
receiving (510) from a server (360) data associated with historical data (368) of a particular user (354) of the recreational apparatus (352) or of a plurality of recreational apparatuses (352);
sending (508) to the recreational apparatus (352) the data associated with historical data (368); and
displaying (504) the data associated with the one more conditions (374) sensed by the recreational apparatus (352) and/or the data associated with historical data (368).

20. The method (500) of claim 19, further comprising sending (506) to the server (360) the data associated with the one or more conditions (374) sensed by the recreational apparatus (352).
